(19) United States
(12) Patent Application Publication
(10) Pub. No.: US 2026/0257654 A1
(43) Pub. Date: Sep. 3, 2026

(54) VEHICLE BRAKING CONTROL DEVICE

(71) Applicant: ADVICS CO., LTD., Kariya-shi, Aichi-ken (JP)

(72) Inventor: Keisuke YASUDA, Kariya-shi, Aichi-ken (JP)

(73) Assignee: ADVICS CO., LTD., Kariya-shi, Aichi-ken (JP)

(21) Appl. No.: 19/489,976

(22) PCT Filed: Jun. 7, 2024
(86) PCT No.: PCT/JP2024/020876

§ 371 Date: Dec. 4, 2025

(30) Foreign Application Priority Data
Jun. 8, 2023 (JP) 2023-094504

(51) Int. Cl. B60T 13/14; B60T 8/171; B60T 8/172; B60T 8/40; B60T 13/62

(52) U.S. Cl. CPC B60T 13/148; B60T 8/171; B60T 8/172; B60T 13/142; B60T 13/62; B60T 8/4081; B60T 2220/04; B60T 2270/402; B60T 2270/404; B60T 2270/406; B60T 2270/82

(57) ABSTRACT

A braking control device includes an upper braking unit that outputs a supply pressure by matching a servo pressure generated by a hydraulic pressure generation unit with a target servo pressure calculated based on an operation amount of a braking operation member, and a lower braking unit disposed between the upper braking unit and a wheel cylinder. The upper braking unit stops the hydraulic pressure generation unit in a case of a first abnormality in which the servo pressure is insufficient, and continues an operation of the hydraulic pressure generation unit in a case of a second abnormality in which the servo pressure is sufficient but the supply pressure is insufficient. In the case of the first and second abnormalities, the lower braking unit increases the supply pressure and outputs the increased supply pressure to the wheel cylinder.

### TECHNICAL FIELD

The present disclosure relates to a vehicle braking control device.

### BACKGROUND ART

PTL 1 discloses that a master pressure control device (also referred to as an “upper braking unit”) including a first brake operation amount detection device that detects a brake operation amount, and a wheel pressure control device (also referred to as a “lower braking unit”) including a second brake operation amount detection device that is connected to the master pressure control device via a communication line, performs control different from that of the master pressure control device, and detects a brake operation amount are provided for the purpose of generating a brake force as requested by a driver as in a normal state even when a brake booster fails, the wheel pressure control device includes a failure determination unit that determines a failure of the master pressure control device, and when the failure determination unit determines a failure of the master pressure control device, a wheel cylinder pressure of each wheel is controlled based on a brake operation amount detected by the second brake operation amount detection device.

Specifically, in a device disclosed in PTL 1, the necessity of backup control by the wheel pressure control device is determined based on contents of a failure. For example, in the case of a serious failure such as a failure of a stroke sensor (also referred to as an “operation displacement sensor”), an electric motor, or the like, it is determined that backup is necessary, but in the case of a minor failure, it is determined that backup is unnecessary. In the backup control, a target wheel pressure is calculated based on a brake operation amount, and a gate in valve, a gate out valve, and an electric motor 55 are driven based on the target wheel pressure to control a wheel pressure.

In the device disclosed in PTL 1, when an abnormality of the upper braking unit is minor, the backup control by the lower braking unit is not performed. However, in a minor abnormality, an output of the upper braking unit is not completely lost, and the output may decrease. Further, the degree of the output decrease varies depending on an abnormal portion in the upper braking unit.

### CITATION LIST

### Patent Literature

PTL 1: JP2009-227103A

### SUMMARY

### Technical Problem

In view of the above problems, an object of the present disclosure is to provide a vehicle braking control device that can appropriately deal with an abnormality according to a portion where the abnormality occurs.

### Solution to Problem

A vehicle braking control device (SC) according to the present disclosure includes an upper braking unit (SA) configured to output a supply pressure (Ps) by matching a servo pressure (Pa) generated by a hydraulic pressure generation unit (PU) with a target servo pressure (Pat) calculated based on an operation amount (Ba) of a braking operation member (BP), and a lower braking unit (SZ) disposed between the upper braking unit (SA) and a wheel cylinder (CW).

In the vehicle braking control device (SC) according to the present disclosure, the upper braking unit (SA) stops the hydraulic pressure generation unit (PU) in the case of a first abnormality in which the servo pressure (Pa) is insufficient, and continues an operation of the hydraulic pressure generation unit (PU) in the case of a second abnormality in which the servo pressure (Pa) is sufficient but the supply pressure (Ps) is insufficient. In the case of the first abnormality and the second abnormality, the lower braking unit (SZ) increases the supply pressure (Ps) and outputs the increased supply pressure (Ps) to the wheel cylinder (CW).

The vehicle braking control device (SC) according to the present disclosure includes a servo pressure sensor (PA) that detects the servo pressure (Pa) as a detected servo pressure (Pak), and a supply pressure sensor (PS) that detects the supply pressure (Ps) as a detected supply pressure (Psk). Then, the upper braking unit (SA) sets a first allowable range (Xa) according to a target servo pressure (Pat) and a first threshold pressure (Ha), sets a second allowable range (Xs) according to a target supply pressure (Pst) corresponding to the supply pressure (Ps) and a second threshold pressure (Hs), determines the first abnormality when the detected servo pressure (Pak) transitions out of the first allowable range (Xa), and determines the second abnormality when the detected servo pressure (Pak) transitions within the first allowable range (Xa) but the detected supply pressure (Psk) transitions out of the second allowable range (Xs).

An abnormality of the braking control device SC may occur not only in a power source such as an electric motor MA but also in a hydraulic pressure transmission passage. According to the above configuration, since a portion where an abnormality occurs is identified, a countermeasure corresponding to the portion can be appropriately made. In addition, since two abnormalities are determined, the reliability of determination is improved.

In the vehicle braking control device (SC) according to the present disclosure, the upper braking unit (SA) generates the supply pressure (Ps) by an operation force (Fp) of the braking operation member (BP) in the case of the first abnormality, generates the supply pressure (Ps) by the servo pressure (Pa) in the case of the second abnormality, and applies the operation force (Fp) by a stroke simulator (SS). In the braking control device SC, the supply pressure Ps is generated by the servo pressure Pa, but when the first abnormality occurs, a hydraulic pressure generation device PU (a generation source of the servo pressure Pa) is stopped. Therefore, in the case of the first abnormality, an operation mode is switched from a second operation mode Ms to a first operation mode Mm, and the supply pressure Ps is generated using a muscle strength of a driver as a power source.

### BRIEF DESCRIPTION OF DRAWINGS

FIG. 1 is a schematic diagram illustrating an embodiment of a braking control device SC.

FIG. 2 is a schematic diagram illustrating a lower braking unit SZ.

FIG. 3 is a flowchart illustrating pressure adjustment control processing.

FIG. 4 is a flowchart illustrating first and second appropriateness determination processing.

FIG. 5 is a time series diagram illustrating an operation of the first and second appropriateness determination.

### DESCRIPTION OF EMBODIMENTS

<Symbols of Constituent Members or the like and Subscripts at the End of Symbols>

In the following description, constituent members, calculation processing, signals, features, and values denoted by the same symbols, such as “CW”, have the same function. Subscripts “f” and “r” added to the end of the symbols related to respective wheels are comprehensive symbols indicating which system of front and rear wheels these subscripts relate to. For example, wheel cylinders CW provided in wheels are expressed as a “front wheel cylinder CWf and a rear wheel cylinder CWr”. Furthermore, the subscripts “f” and “r” at the end of the symbols can be omitted. When the subscripts “f” and “r” are omitted, each symbol represents a generic term. For example, “CW” is a generic term for wheel cylinders provided in front and rear wheels of a vehicle. Further, “CW” as a generic term is also referred to as “CW (=CWf, CWr)”.

In a fluid passage, a side close to a master cylinder CM (a side far from a wheel cylinder CW) is referred to as an “upper portion”, and a side close to a wheel cylinder CW (a side far from the master cylinder CM) is referred to as a “lower portion”. In circulation flows KN and KZ of a braking fluid BF, a side close to discharge portions of fluid pumps QA and QZ (a side away from suction portions) is referred to as an “upstream side”, and a side close to the suction portions of the fluid pumps QA and QZ (a side away from the discharge portions) is referred to as a “downstream side”.

An upper actuator YA of an upper braking unit SA, a lower actuator YZ of a lower braking unit SZ, and the wheel cylinder CW are connected by a fluid passage (a communication passage HS). Furthermore, in the upper and lower actuators YA and YZ, various components (UA and the like) are connected by a fluid passage. Here, the “fluid passage” is a passage for moving the braking fluid BF, and includes a pipe, a flow passage in an actuator, a hose, and the like. In the following description, the communication passage HS, a reflux passage HK, a return passage HZ, a reservoir passage HR, an input passage HN, a servo passage HC, a depressurization passage HG, and the like are fluid passages.

### <Names of Various Hydraulic Pressures>

In the braking control device SC, a pressure of the braking fluid BF (also referred to as a “hydraulic pressure”) is transmitted from the upper braking unit SA to the wheel cylinder CW via the lower braking unit SZ. The upper braking unit SA includes a hydraulic pressure generation unit PU as a pressurizing source. In the following description, names of various hydraulic pressures are as follows. A “servo pressure Pa” is a hydraulic pressure generated by the hydraulic pressure generation unit PU. A “supply pressure Ps” is a hydraulic pressure transmitted (supplied) from the upper braking unit SA to the lower braking unit SZ. A “wheel pressure Pw” is a hydraulic pressure transmitted (supplied) from the lower braking unit SZ to the wheel cylinder CW, and is an internal pressure of the wheel cylinder CW. A “master pressure Pm” is an internal pressure of a master cylinder CM. In a configuration in which the supply pressure Ps is output from the master cylinder CM to the lower braking unit SZ, the master pressure Pm is the supply pressure Ps in the upper braking unit SA. On the other hand, in a configuration in which the supply pressure Ps is directly output from the hydraulic pressure generation unit PU to the lower braking unit SZ, the servo pressure Pa is the supply pressure Ps in the upper braking unit SA.

### <Target Value, Actual Value, and Detected Value>

In hydraulic pressure control, an “actual value” is controlled to be close to and match a “target value”. The actual value includes a “detected value” and an “estimated value”. The detected value is a value detected by a hydraulic pressure sensor. The estimated value is a value calculated using a certain relationship based on values (various state quantities and the like) acquired as different physical quantities. For example, in hydraulic pressure control performed by electromagnetic valves UA and UZ, a hydraulic pressure to be adjusted is uniquely determined according to a current supplied to the electromagnetic valves UA and UZ. Therefore, “control for matching the actual value with the target value” includes not only closed-loop control based on a detected value of a hydraulic pressure sensor (that is, control in which a detected value is fed back), but also open-loop control by adjusting a physical quantity (for example, a supply current) different from a hydraulic pressure (that is, control in which a detected value is not fed back). That is, the “control for matching the actual value with the target value” includes a configuration that does not include a hydraulic pressure sensor. On the other hand, the hydraulic pressure sensor that detects an actual value is an essential component in appropriateness determination. In the following description, a detected value of a hydraulic pressure sensor (a detected servo pressure, a detected supply pressure, and the like) is specified as necessary.

### Embodiment of Braking Control Device SC

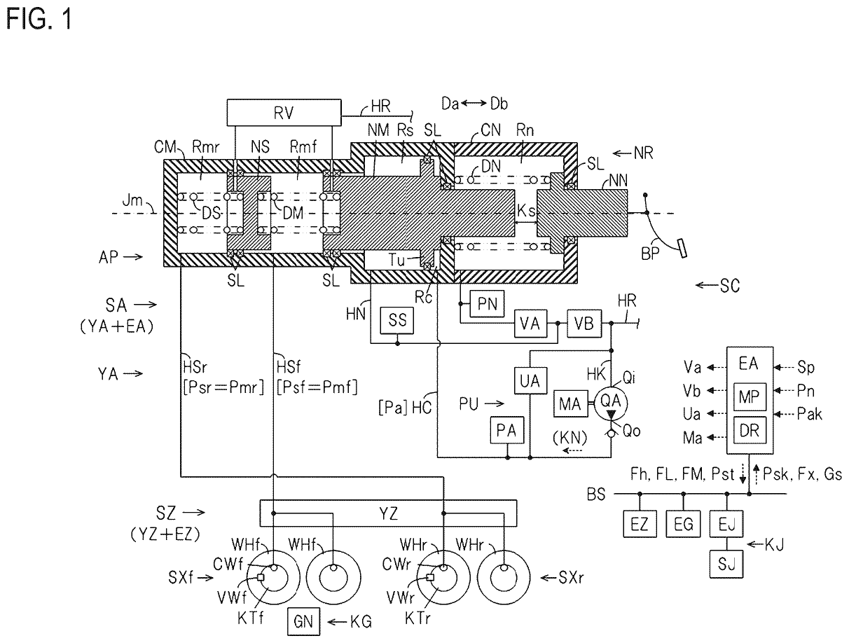

An embodiment of the vehicle braking control device SC (particularly, the upper braking unit SA) will be described with reference to a schematic diagram in FIG. 1. The braking control device SC includes the upper braking unit SA and the lower braking unit SZ. For example, the braking control device SC is applied to a hybrid vehicle including an electric motor for traveling or an electric vehicle.

Front and rear wheels WHf and WHr (=WH) of a vehicle are provided with a braking device SX (=SXf, SXr). The braking device SX includes a brake caliper, a friction member (for example, a brake pad), and a rotating member KT (for example, a brake disc). The brake caliper (not illustrated) is provided with the wheel cylinder CW. The friction member (not illustrated) is pressed against the rotating member KT fixed to each wheel WH by a hydraulic pressure Pw (referred to as a “wheel pressure”) in the wheel cylinder CW, so that a braking torque Tb is applied to the wheel. As a result, a friction braking force Fe (also referred to as a “hydraulic braking force”) is generated at the wheel WH. Therefore, the braking device SX can be referred to as a “device that generates the friction braking force Fe by the wheel pressure Pw” or a “device that converts the wheel pressure Pw into the friction braking force Fe”.

The vehicle includes a regeneration device KG. The regeneration device KG includes a generator GN for energy regeneration (also referred to as an “electric motor or a generator” or a “regeneration generator”), a control unit EG for the regeneration device KG (also referred to as a “regeneration controller”), and a regeneration storage battery (not illustrated). The regeneration generator GN is also an electric motor for traveling. In regeneration braking, the electric motor or the generator GN operates as an electric power generator, and generated electric power is stored in the regeneration storage battery via the regeneration controller EG. In this case, a regeneration braking force Fg acts on a wheel. That is, the regeneration device KG can generate the regeneration braking force Fg. For example, the regeneration device KG is provided at the front wheel WHf. Therefore, the regeneration braking force Fg is generated at the front wheel WHf. The regeneration device KG (particularly, the regeneration controller EG) is connected to a communication bus BS.

The vehicle includes a driving support device KJ. In the driving support device KJ, automatic speed control is performed. The driving support device KJ includes an object detection sensor SJ and a controller EJ for driving support (also simply referred to as a “driving support controller”). The object detection sensor SJ detects a distance Sj (referred to as a “relative distance”, and also referred to as an “inter-vehicle distance” when an object is a preceding vehicle) to an object present in front of the vehicle (including a preceding vehicle traveling in front of the vehicle). For example, the object detection sensor SJ may be a radar sensor, a millimeter wave sensor, an image sensor, or the like. The driving support controller EJ calculates a target acceleration Gs of the vehicle (a target value of a vehicle body acceleration in a front-rear direction of the vehicle) based on the detection result Sj (the relative distance) of the object detection sensor SJ. The driving support device KJ (particularly, the driving support controller EJ) is connected to the communication bus BS. The target acceleration Gs is transmitted to the braking control device SC via the communication bus BS. Braking forces Fg and Fe are adjusted according to the target acceleration Gs in the braking control device SC. As a result, a traveling speed Vx (a vehicle body speed) of the vehicle is controlled.

The vehicle includes a braking operation member BP and various sensors (SP and the like). The braking operation member BP (for example, a brake pedal) is a member operated by a driver to decelerate the vehicle. The vehicle is provided with an operation displacement sensor SP that detects an operation displacement Sp of the braking operation member BP. The operation displacement Sp is one of state quantities (state variables) indicating an operation amount of the braking operation member BP, and is a signal (that is, a braking instruction) indicating a braking intention of a driver in the brake-by-wire type braking control device SC. In addition to the operation displacement sensor SP, a hydraulic pressure Pn of an input chamber Rn (referred to as an “input pressure”) (which will be described later) is adopted as another state quantity indicating a braking operation amount. The input pressure Pn is detected by an input pressure sensor PN. The operation displacement Sp, the input pressure Pn, and the like are collectively referred to as a “braking operation amount Ba”. The operation displacement sensor SP and the input pressure sensor PN that respectively detect the operation displacement Sp and the input pressure Pn (that is, the braking operation amount Ba) are referred to as a “braking operation amount sensor BA”.

The vehicle is provided with various sensors for braking control for individually controlling the wheel pressure Pw of each wheel, such as anti-lock brake control and side slip prevention control. Specifically, each wheel WH is provided with a wheel speed sensor VW that detects a rotation speed Vw (referred to as a “wheel speed”). In addition, the vehicle includes a steering amount sensor that detects a steering amount Sa (for example, an operation angle) of a steering operation member (for example, a steering wheel), a yaw rate sensor that detects a yaw rate Yr of the vehicle, a front-rear acceleration sensor that detects a front-rear acceleration Gx (also referred to as a “deceleration”) of the vehicle, and a lateral acceleration sensor that detects a lateral acceleration Gy of the vehicle (these sensors are not illustrated).

The vehicle includes the braking control device SC. In the braking control device SC, a front-rear type (also referred to as a “II type”) is adopted for a braking system including two systems. The wheel pressure Pw of each wheel cylinder CW is adjusted by the braking control device SC.

The braking control device SC includes the two braking units SA and SZ. The upper braking unit SA includes the upper actuator YA and an upper controller EA. The upper actuator YA is controlled by the upper controller EA. The lower braking unit SZ includes the lower actuator YZ and a lower controller EZ. The lower actuator YZ is controlled by the lower controller EZ. Here, the upper and lower actuators YA and YZ are also referred to as “upper and lower fluid units”. The upper and lower controllers EA and EZ are also referred to as “upper and lower control units”.

The upper braking unit SA (particularly, the upper controller EZ) and the lower braking unit SZ (particularly, the lower controller EZ) are connected to the communication bus BS. Signal transmission is performed between a plurality of controllers (EA, EZ, EG, EJ, and the like) by the communication bus BS. That is, the plurality of controllers can transmit signals (detected values, calculation values, control flags, and the like) to the communication bus BS, and can receive signals from the communication bus BS.

### <Upper Braking Unit SA>

A configuration of the upper braking unit SA will be described. The upper braking unit SA generates the supply pressure Ps in response to an operation of the braking operation member BP (a brake pedal). The supply pressure Ps is output (supplied) to the lower braking unit SZ (finally, the wheel cylinder CW). The upper braking unit SA includes the upper actuator YA and the upper controller EA.

### <<Upper Actuator YA>>

The upper actuator YA (the upper fluid unit) includes an apply unit AP, a hydraulic pressure generation unit PU, and an input unit NR.

### [Apply Unit AP]

The supply pressure Ps (=Psf, Psr) is output from the apply unit AP in response to an operation of the braking operation member BP. The apply unit AP includes a tandem type master cylinder CM and primary and secondary master pistons NM and NS.

The primary and secondary master pistons NM and NS are inserted into the tandem master cylinder CM. The inside of the master cylinder CM is divided into four hydraulic pressure chambers Rmf, Rmr, Rc, and Rs by the two master pistons NM and NS. The front wheel and rear wheel master chambers Rmf and Rmr (=Rm) are divided by one side bottom of the master cylinder CM and the master pistons NM and NS. Furthermore, the inside of the master cylinder CM is partitioned into the servo chamber Rc and the reaction force chamber Rs by a flange portion Tu of the master piston NM. The master chamber Rm and the servo chamber Rc are arranged to face each other with the flange portion Tu interposed therebetween. A pressure receiving area rm of the master chamber Rm and a pressure receiving area rc of the servo chamber Rc are made equal. The hydraulic pressure chambers Rmf, Rmr, Rc, and Rs are sealed with respect to the master cylinder CM by a seal member SL.

At the time of non-braking, the master pistons NM and NS are each at a most retreating position (that is, a position at which a volume of the master chamber Rm is largest). In this state, the master chamber Rm of the master cylinder CM communicates with a master reservoir RV. The braking fluid BF is stored in the master reservoir RV (also referred to as an “atmospheric pressure reservoir”). When the braking operation member BP is operated, the master pistons NM and NS are moved in a forward direction Da (a direction in which the volume of the master chamber Rm decreases). The communication between the master chamber Rm and the master reservoir RV is blocked by the movement. When the master pistons NM and NS are further moved in the forward direction Da, hydraulic pressures Pmf and Pmr in the front wheel and rear wheel master chambers Rmf and Rmr (also referred to as “front wheel and rear wheel master pressures”) are increased from “0 (atmospheric pressure)”. Accordingly, the braking fluid BF pressurized to the master pressure Pm (=Pmf, Pmr) is output (pressure-fed) from the master chamber Rm (=Rmf, Rmr) of the master cylinder CM to the lower braking unit SZ as front wheel and rear wheel supply pressures Psf and Psr (=Ps).

### [Hydraulic Pressure Generation Unit PU]

The servo pressure Pa is supplied to the servo chamber Rc of the apply unit AP by the hydraulic pressure generation unit PU. The hydraulic pressure generation unit PU includes an electric motor MA, a fluid pump QA, and a pressure adjustment valve UA.

The fluid pump QA is driven by the electric motor MA. The electric motor MA is a power source for generating the servo pressure Pa. Since the electric motor MA and the fluid pump QA are provided in the upper braking unit SA, the electric motor MA and the fluid pump QA are also referred to as an “upper electric motor MA” and an “upper fluid pump QA”.

In the fluid pump QA, a suction portion Qi and a discharge portion Qo are connected by a reflux passage HK (a fluid passage). The suction portion Qi of the fluid pump QA is connected to the master reservoir RV via the reservoir passage HR. A check valve is provided at the discharge portion Qo of the fluid pump QA.

The reflux passage HK is provided with a normally open type pressure adjustment valve UA. The pressure adjustment valve UA is a linear type electromagnetic valve in which a valve opening amount is continuously controlled based on an energization state (for example, a supply current Ia). The pressure adjustment valve UA adjusts a hydraulic pressure difference (a differential pressure) between the upstream side and the downstream side, and thus the pressure adjustment valve UA is also referred to as a “differential pressure valve”.

When the braking fluid BF is discharged from the fluid pump QA, a circulation flow KN (indicated by a dashed arrow) of the braking fluid BF is generated in the reflux passage HK. When the pressure adjustment valve UA is in a fully open state (at the time of non-energization since the pressure adjustment valve UA is of a normally open type), the hydraulic pressure Pa (referred to as a “servo pressure”) between the discharge portion Qo of the fluid pump QA and the pressure adjustment valve UA in the reflux passage HK is “0 (the atmospheric pressure) ”. When a current Ia supplied to the pressure adjustment valve UA (also referred to as a “pressure adjustment valve current”) is increased, the circulation flow KN (a flow of the braking fluid BF circulating in the reflux passage HK) is throttled by the pressure adjustment valve UA. In other words, a flow passage of the reflux passage HK is narrowed by the pressure adjustment valve UA, and an orifice effect due to the pressure adjustment valve UA is exhibited. Accordingly, the hydraulic pressure Pa on the upstream side of the pressure adjustment valve UA is increased from “0”. That is, in the circulation flow KN, the hydraulic pressure difference (the differential pressure) is generated between the hydraulic pressure Pa (the servo pressure) on the upstream side of the pressure adjustment valve UA and the hydraulic pressure (the atmospheric pressure) on the downstream side of the pressure adjustment valve UA. The differential pressure is adjusted by an energization amount Ia to the pressure adjustment valve UA.

The reflux passage HK is connected to the servo chamber Rc via a servo passage HC (a fluid passage) between the discharge portion Qo of the fluid pump QA and the pressure adjustment valve UA. Therefore, the servo pressure Pa is introduced (supplied) to the servo chamber Rc. Due to the increase in the servo pressure Pa, the master pistons NM and NS are pressed in the forward direction Da (the direction in which the volume of the master chamber Rm decreases), and the hydraulic pressures Pmf and Pmr (front wheel and rear wheel master pressures) in the front wheel and rear wheel master chambers Rmf and Rmr are increased.

The front wheel and rear wheel master chambers Rmf and Rmr (=Rm) are connected to front wheel and rear wheel communication passages HSf and HSr (=HS). The front wheel and rear wheel communication passages HSf and HSr (fluid passages) are connected to the front wheel and rear wheel cylinders CWf and CWr (=CW) via the lower braking unit SZ (in particular, the lower fluid unit YZ). Therefore, the master pressure Pm is supplied from the upper braking unit SA to the wheel cylinder CW as the supply pressure Ps. Here, the front wheel supply pressure Psf (=Pmf) and the rear wheel supply pressure Psr (=Pmr) are equal (that is, “Psf=Psr”).

The hydraulic pressure generation unit PU is provided with a servo pressure sensor PA to detect the servo pressure Pa. The servo pressure Pa detected by the servo pressure sensor PA is referred to as a “detected servo pressure Pak”. The detected servo pressure Pak is input to the upper controller EA.

### [Input Unit NR]

Regenerative cooperation control is implemented by the input unit NR. The “regenerative cooperation control” is control to cause a friction braking force Fe (a braking force generated by the wheel pressure Pw) and a regeneration braking force Fg (a braking force generated by the regeneration generator GN) to function together such that kinetic energy of the vehicle can be efficiently recovered into electric energy during the braking. The braking operation member BP is operated by the input unit NR in the regenerative cooperation control, but a state in which no wheel pressure Pw is generated occurs.

The input unit NR includes an input cylinder CN, an input piston NN, an introduction valve VA, a release valve VB, a stroke simulator SS, and an input pressure sensor PN.

The input cylinder CN is fixed to the master cylinder CM. The input piston NN is inserted into the input cylinder CN. The input piston NN is mechanically connected to the braking operation member BP via a clevis (a U-shaped link) so as to be movably interlocked with the braking operation member BP (a brake pedal). An end surface of the input piston NN and an end surface of the master piston NM have a gap Ks (also referred to as a “separation displacement”). The regenerative cooperation control is achieved by adjusting the separation distance Ks by the servo pressure Pa. Similar to the hydraulic pressure chambers Rm, Rc, and Rs, the input chamber Rn is also sealed by a seal member SL.

The input chamber Rn of the input unit NR is connected to the reaction force chamber Rs of the apply unit AP via the input passage HN (a fluid passage). A normally close type introduction valve VA is provided in the input passage HN. The input passage HN is connected to the master reservoir RV via the reservoir passage HR (a fluid passage) between the introduction valve VA and the reaction force chamber Rs. The reservoir passage HR is provided with a normally open type release valve VB. The introduction valve VA and the release valve VB are on-off type electromagnetic valves. The stroke simulator SS is provided in the input passage HN between the introduction valve VA and the reaction force chamber Rs. The input pressure sensor PN is provided in the input passage HN between the input chamber Rn and the introduction valve VA to detect a hydraulic pressure Pn (an input pressure) in the input chamber Rn. The input pressure Pn detected by the input pressure sensor PN is input to the upper controller EA as the braking operation amount Ba.

When electric power is not supplied to the introduction valve VA and the release valve VB, the introduction valve VA is closed and the release valve VB is opened. The input chamber Rn is sealed by closing the introduction valve VA, and is fluidly locked. Accordingly, the master piston NM is displaced integrally with the braking operation member BP. The stroke simulator SS and the reaction force chamber Rs communicate with the master reservoir RV by opening the release valve VB.

When electric power is supplied to the introduction valve VA and the release valve VB, the introduction valve VA is opened, and the release valve VB is closed. Accordingly, the master piston NM can be separately displaced from the braking operation member BP. In this case, since the input chamber Rn is connected to the stroke simulator SS, the operation force Fp of the braking operation member BP is generated by the stroke simulator SS. Specifically, a volume of the input chamber Rn is reduced by an operation of the braking operation member BP, and the braking fluid BF is discharged from the input chamber Rn. The discharged braking fluid BF flows into the stroke simulator SS. An elastic body (for example, a compression spring) is provided inside the stroke simulator SS to generate a force for preventing the inflow of the braking fluid BF. Accordingly, the operation force Fp of the braking operation member BP is generated.

An operation mode of the braking operation member BP when electric power is not supplied to the introduction valve VA and the release valve VB in the input unit NR is referred to as a “first operation mode Mm”. The first operation mode Mm is used when the hydraulic pressure generation device PU is stopped due to an abnormality (including a power supply failure). In the first operation mode Mm (also referred to as a “manual mode”), since the input chamber Rn is fluidly locked, the master pistons NM and NS are moved integrally with the braking operation member BP. In the first operation mode Mm, the supply pressure Ps is generated by the operation force Fp of the braking operation member BP (that is, “Ps=Pm”). That is, in the first operation mode Mm, the supply pressure Ps is generated using a muscle strength of a driver as a power source. In this case, the operation force Fp is applied by rigidity (that is, elastic deformation of a brake caliper, a friction member, a braking pipe, and the like) of the braking device SX (a device that generates the friction braking force Fe by the wheel pressure Pw).

On the other hand, an operation mode of the braking operation member BP when electric power is supplied to the introduction valve VA and the release valve VB in the input unit NR is referred to as a “second operation mode Ms”. The second operation mode Ms is used when the hydraulic pressure generation device PU is operating. In the second operation mode Ms (also referred to as a “by-wire mode”), since the braking fluid BF discharged from the input chamber Rn flows into the stroke simulator SS, the master pistons NM and NS can be moved separately from the braking operation member BP. In the second operation mode Ms, the supply pressure Ps is generated by the servo pressure Pa. That is, the muscle strength of the driver (that is, the operation force Fp) is not used as a power source for generating the servo pressure. In this case, the operation force Fp of the braking operation member BP is applied by the stroke simulator SS.

### <<Upper Controller EA>>

The upper actuator YA is controlled by the upper controller EA. The upper controller EA includes a microprocessor MP and a drive circuit DR. The upper controller EA is connected to the communication bus BS such that signals (detected values, calculation values, control flags, and the like) can be shared with various controllers (EZ, EG, EJ, and the like).

Various sensor signals such as the operation displacement Sp, the input pressure Pn, and the detected servo pressure Pak are input to the upper controller EA. Further, various signals such as the target acceleration Gs, the Detected Supply Pressure Psk, and a Limit regeneration braking force Fx are input to the upper controller EA from the communication bus BS. The upper controller EA outputs a target regeneration braking force Fh (a target value of the regeneration braking force Fg), a first appropriateness flag FL (a control flag indicating an operation state of the hydraulic pressure generation unit PU), a second appropriateness flag FM (a control flag indicating an operation state of the upper braking unit SA), and the like to the communication bus BS. The regeneration controller EG controls the regeneration braking force Fg (an actual value) based on the target regeneration braking force Fh (a target value) acquired from the communication bus BS.

An algorithm for pressure adjustment control is programmed in the upper controller EA (in particular, the microprocessor MP). The “pressure adjustment control” is a control for controlling the servo pressure Pa and finally adjusting the wheel pressure Pw (=Pwf, Pwr). The pressure adjustment control includes regenerative cooperation control. The pressure adjustment control is executed based on the various signals (Sp and the like) described above.

The hydraulic pressure generation unit PU (MA, UA, and the like) is driven by the drive circuit DR based on the algorithm for the pressure adjustment control. In the drive circuit DR, an H-bridge circuit is implemented by a switching element (for example, a MOS-FET) to drive the electric motor MA. The drive circuit DR includes a switching element to drive various electromagnetic valves (UA and the like). In addition, the drive circuit DR includes a motor current sensor (not illustrated) that detects a current Im supplied to the electric motor MA (referred to as a “motor current”), and a pressure adjustment valve current sensor (not illustrated) that detects a current Ia supplied to the pressure adjustment valve UA (referred to as a “pressure adjustment valve current”). The electric motor MA is provided with a rotation speed sensor (not illustrated) that detects rotation speed Na. Alternatively, the electric motor MA may be provided with a rotation angle sensor (not illustrated) that detects a rotation angle Ka, and the motor rotation speed Na may be calculated based on the detected motor rotation angle Ka. The motor rotation speed Na can be estimated based on the motor current Im.

The upper controller EA calculates a target current Iat based on the braking operation amount Ba (a generic name of Sp and Pn). The “target current Iat” is a target value corresponding to the pressure adjustment valve current Ia (an actual value). In the upper controller EA, the pressure adjustment valve current Ia detected d by the pressure adjustment valve current sensor is controlled to be close to and match with the target current Iat.

The upper controller EA calculates a target rotation speed Nt based on the operation displacement Sp. The “target rotation speed Nt” is a target value corresponding to the motor rotation speed Na (an actual value). For example, the operation displacement Sp is time-differentiated to calculate an operation speed dS. When the operation displacement Sp increases, the target rotation speed Nt is determined to increase as the operation speed dS (an increase amount of the operation displacement Sp per unit time) increases. When the operation displacement Sp is reduced or maintained constant, the target rotation speed Nt is reduced.

In the target rotation speed Nt, a minimum flow rate of the pressure adjustment valve UA and a minimum rotation speed of the electric motor MA are taken into consideration. The “minimum flow rate” is a minimum flow rate required for the pressure adjustment valve UA to function. The “minimum rotation speed” is a minimum value of a speed at which the electric motor MA can stably rotate. In consideration of the minimum flow rate and the minimum rotation speed, a lower limit speed nt (a predetermined value set in advance) is set for the target rotation speed Nt. That is, when the target rotation speed Nt is equal to or higher than the lower limit speed nt, there is no limitation by the lower limit speed nt, and the calculated target rotation speed Nt is used directly. On the other hand, when the target rotation speed Nt is less than the lower limit speed nt, the target rotation speed Nt is determined by the lower limit speed nt. Then, the motor current Im is controlled such that the motor rotation speed Na is close to and matches with the target rotation speed Nt.

In the upper controller EA, a drive signal Ma for controlling the electric motor MA and drive signals Ua, Va, and Vb for controlling the various electromagnetic valves UA, VA, and VB are calculated based on these control algorithms. Then, according to the drive signals (Ma and the like), switching elements of the drive circuit DR are driven, and the electric motor MA and the electromagnetic valves UA, VA, and VB are controlled.

### <Lower Braking Unit SZ>

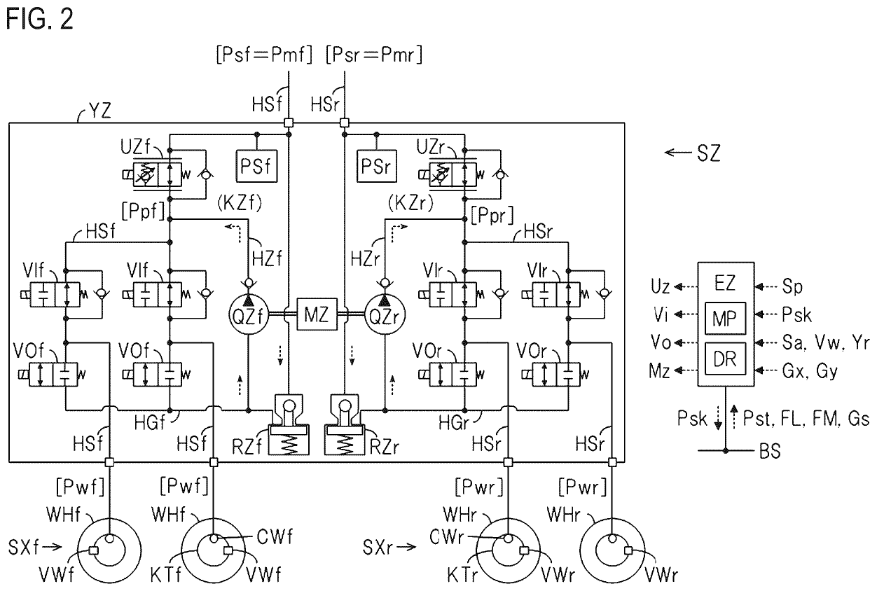

A configuration of the lower braking unit SZ will be described with reference to a schematic diagram of FIG. 2. The lower braking unit SZ is a general-purpose unit for performing antilock brake control, traction control, side slip prevention control, and the like. In addition, complementary control is performed in the lower braking unit SZ. The “complementary control” compensates for the shortage of the supply pressure Ps from the upper braking unit SA.

The front wheel and rear wheel master pressures Pmf and Pmr are input from the upper braking unit SA to the lower braking unit SZ as the front wheel and rear wheel supply pressures Psf and Psr (that is, “Psf=Pmf, Psr=Pmr”). Then, in the lower braking unit SZ, the front wheel and rear wheel supply pressures Psf and Psr (=Ps) are adjusted (increased or decreased), and are output as hydraulic pressures Pwf and Pwr of the front wheel and the rear wheel cylinders CWf and CWr (front wheel and rear wheel pressures). The lower braking unit SZ includes the lower actuator YZ and the lower controller EZ.

### <<Lower Actuator YZ>>

The lower actuator YZ (the lower fluid unit) is provided between the upper actuator YA and the wheel cylinder CW in the communication passage HS. The lower actuator YZ includes a control valve UZ, a supply pressure sensor PS, a fluid pump QZ, an electric motor MZ, a pressure adjustment reservoir RZ, an inlet valve VI, and an outlet valve VO.

The control valve UZ (=UZf, UZr) is provided in the communication passage HS (=HSf, HSr). The control valve UZ is a normally open type linear electromagnetic valve (a differential pressure valve), which is similar to the pressure adjustment valve UA. The front and rear wheel pressures Pwf and Pwr can be increased from the front and rear wheel supply pressures Psf and Psr by the front and rear wheel control valves UZf and UZr. In the lower braking unit SZ, the front and rear wheel pressures Pwf and Pwr can be individually adjusted by the front and rear wheel control valves UZf and UZr.

Front and rear wheel supply pressure sensors PSf and PSr (=PS) are provided at an upper portion of the control valve UZ (a portion of the communication passage HS on a side closer to the upper actuator YA) so as to detect the front and rear wheel supply pressures Psf and Psr (=Ps). The supply pressure Ps (=Psf, Psr) detected by the supply pressure sensor PS (=PSf, PSr) is referred to as a “detected supply pressure Psk (=Pskf, Pskr)”. The detected supply pressure Psk is input to the lower controller EZ. Here, the rear wheel supply pressure sensor PSr can be omitted.

An upper portion and a lower portion of the control valve UZ (=UZf, UZr) are connected by the return passage HZ (=HZf, HZr). The return passage HZ (a fluid passage) is provided with the fluid pump QZ (=QZf, QZr) and a pressure adjustment reservoir RZ (=RZf, RZr). The fluid pump QZ is driven by the electric motor MZ. The electric motor MZ is a power source for increasing the supply pressure Ps (=Psf, Psr). Since the electric motor MZ and the fluid pump QZ are included in the lower braking unit SZ, the electric motor MZ and the fluid pump QZ are also referred to as a “lower electric motor MZ” and a “lower fluid pump QZ”.

When the electric motor MZ is driven, the braking fluid BF is suctioned from the upper portion of the control valve UZ and discharged to the lower portion of the control valve UZ by the fluid pump QZ. Accordingly, a circulation flow KZ (indicated by a dashed arrow) of the braking fluid BF including the pressure adjustment reservoir RZ is formed in the communication passage HS and the return passage HZ. When a flow passage of the communication passage HS is throttled and the circulation flow KZ of the braking fluid BF is throttled by the control valve UZ, the orifice effect in this case increases a hydraulic pressure Pp (referred to as an “adjustment pressure”) at the lower portion of the control valve UZ from a hydraulic pressure Ps (a supply pressure) at the upper portion of the control valve UZ. Similar to the servo pressure Pa, in a magnitude relationship between the supply pressure Ps and the adjustment pressure Pp, the adjustment pressure Pp is equal to or higher than the supply pressure Ps (that is, “Pp≥PS”). In other words, the adjustment pressure Pp can be increased from the supply pressure Ps.

Inside the lower actuator YZ, the front wheel and rear wheel communication passages HSf and HSr are each branched into two and are respectively connected to the front wheel and rear wheel cylinders CWf and CWr. The normally open type inlet valve VI and the normally close type outlet valve VO are provided for each wheel cylinder CW such that each wheel pressure Pw can be adjusted individually. Specifically, the inlet valve VI is provided in the branched communication passage HS (that is, on a side closer to the wheel cylinder CW than a branched portion of the communication passage HS). The communication passage HS is connected to the pressure adjustment reservoir RZ via a depressurization passage HG (a fluid passage) at a lower portion of the inlet valve VI (a portion of the communication passage HS on a side close to the wheel cylinder CW). The outlet valve VO is disposed in the depressurization passage HG. On-off type electromagnetic valves are adopted as the inlet valve VI and the outlet valve VO. The wheel pressure Pw can be individually adjusted for each wheel by the inlet valve VI and the outlet valve VO.

When the inlet valve VI and the outlet valve VO are not supplied with electric power and operations thereof are stopped, the inlet valve VI is opened and the outlet valve VO is closed. In this state, the wheel pressure Pw is equal to the adjustment pressure Pp. The wheel pressure Pw is independently adjusted for each wheel cylinder CW by driving the inlet valve VI and the outlet valve VO. In order to decrease the wheel pressure Pw, the inlet valve VI is closed and the outlet valve VO is opened. The braking fluid BF is prevented from flowing into the wheel cylinder CW, and the braking fluid BF in the wheel cylinder CW flows out to the pressure adjustment reservoir RZ, and thus the wheel pressure Pw is decreased. In order to increase the wheel pressure Pw, the inlet valve VI is opened and the outlet valve VO is closed. The braking fluid BF is prevented from flowing out to the pressure adjustment reservoir RZ, and the adjustment pressure Pp from the pressure adjustment valve UZ is supplied to the wheel cylinder CW, and thus the wheel pressure Pw is increased. However, an upper limit of the increase is the adjustment pressure Pp. In order to maintain the wheel pressure Pw, both the inlet valve VI and the outlet valve VO are closed. Since the wheel cylinder CW is fluidically sealed, the wheel pressure Pw is maintained constant.

### <<Lower Controller EZ>

The lower actuator YZ is controlled by the lower controller EZ (a lower control unit). The lower controller EZ includes the microprocessor MP and the drive circuit DR, which is similar to the upper controller EA. The lower controller EZ is connected to the communication bus BS. Therefore, the upper controller EA and the lower controller EZ can share a signal via the communication bus BS.

Sensor signals such as an operation displacement Sp, a detected supply pressure Psk, a wheel speed Vw, a steering amount Sa, a yaw rate Yr, a front-rear acceleration Gx, and a lateral acceleration Gy are input to the lower controller EZ (particularly, the microprocessor MP). Further, a target acceleration Gs, a target supply pressure Pst, first and second appropriateness flags FL and FM, and the like are input to the lower controller EZ from the communication bus BS. The lower controller EZ calculates a traveling speed Vx (also referred to as a “vehicle body speed”) of the vehicle based on the wheel speed Vw. The lower controller EZ performs anti-lock brake control (so-called ABS control) for preventing locking of a wheel WH, traction control for preventing spinning of a drive wheel, and side slip prevention control (so-called ESC) for preventing understeer and oversteer to improve directional stability of the vehicle. Further, the lower controller EZ performs complementary control (which will be described later) to cope with an abnormality of the braking control device SC (the hydraulic pressure generation unit PU or the like), in addition to the above-described control.

The electric motor MZ and various electromagnetic valves (UZ and the like) constituting the lower actuator YZ are driven by the drive circuit DR according to a control algorithm programmed in the microprocessor MP by the lower controller EZ. In the drive circuit DR of the lower controller EZ, an H-bridge circuit is implemented by a switching element (for example, a MOS-FET) to drive the electric motor MZ. The drive circuit DR includes a switching element to drive various electromagnetic valves (UZ and the like). In addition, the drive circuit DR includes a motor current sensor (not illustrated) that detects a current In supplied to the electric motor MZ and a control valve current sensor IZ (not illustrated) that detects a current Iz supplied to the control valve UZ (referred to as a “control valve current”). A drive signal Mz of the electric motor MZ, a drive signal Uz of the control valve UZ, a drive signal Vi of the inlet valve VI, and a drive signal Vo of the outlet valve VO are calculated based on the control algorithm. The drive circuit DR controls the electric motor MZ and the electromagnetic valves UZ, VI and VO based on the drive signals (Uz and the like).

### <Processing of Pressure Adjustment Control>

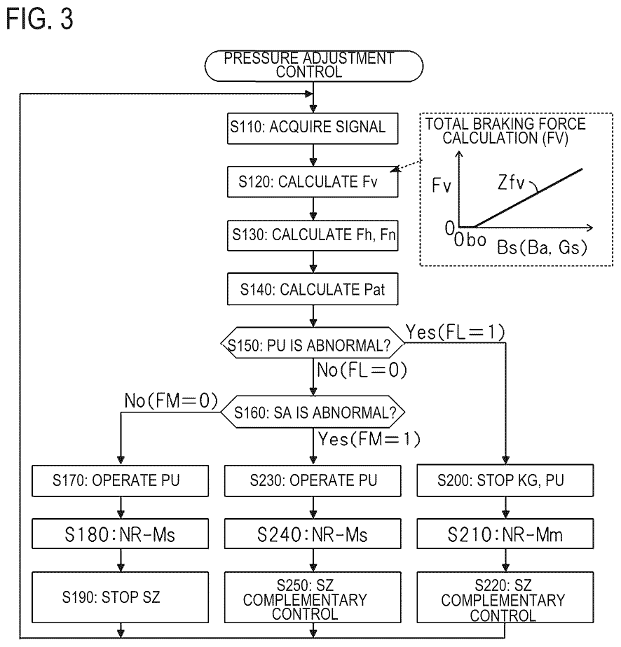

A processing example of the pressure adjustment control will be described with reference to a flowchart of FIG. 3. The pressure adjustment control includes first and second appropriateness determination and complementary control in addition to regenerative cooperation control of the regeneration device KG and the braking control device SC. In the first and second appropriateness determination, it is determined “whether a device operation is normal or abnormal”. When a device failure occurs and there is an abnormality, the shortage of the supply pressure Ps is compensated by the complementary control in the lower braking unit SZ. The pressure adjustment control excluding the complementary control is performed by the upper controller EA, and the complementary control is performed by the lower controller EZ.

In the description of the processing example, the following is assumed.
The regeneration device KG is provided only in the front wheel WHf. Therefore, the regeneration braking force Fg acts on the front wheel WHf and does not act on the rear wheel WHr.
When the braking control device SC operates normally, the lower actuator YZ is not driven, and only the upper actuator YA is driven. Therefore, when the upper braking unit SA is normal, the wheel pressure Pw is adjusted only by the upper actuator YA, so that the supply pressure Ps and the wheel pressure Pw match with each other (that is, “Ps=Pw”).
In the upper actuator YA, a pressure receiving area rm of the master chamber Rm (also referred to as a “master area”) and a pressure receiving area rc of the servo chamber Rc (also referred to as a “servo area”) are set to be equal (that is, “rm=rc”). Therefore, when the friction of the seal member SL is ignored, “Pa=Pm” in a static state.
The rear wheel supply pressure sensor PSr is omitted. Therefore, the supply pressure sensor PS is the front wheel supply pressure sensor PSf, and the detected supply pressure Psk is the front wheel detected supply pressure Pskf. Here, the supply pressure sensor PS is built in the lower actuator YZ, and the detected supply pressure Psk is input to the lower controller EZ. Further, the detected supply pressure Psk is acquired by the upper controller EA through the communication bus BS.

Various braking forces are as follows.
A “vehicle body total braking force Fu” is an actual braking force that acts on the entire vehicle. A target value corresponding to the vehicle body total braking force Fu is a “target total braking force Fv”.
A “friction braking force Fe (a hydraulic braking force) ” is a braking force actually generated by the wheel pressure Pw. A target value corresponding to the friction braking force Fe is a “target friction braking force Fn”.
A “regeneration braking force Fg” is a braking force actually generated by the regeneration device KG. A target value corresponding to the regeneration braking force Fg is a “target regeneration braking force Fh” The target regeneration braking force Fh is calculated by the upper braking unit SA (in particular, the upper controller EA), and is transmitted to the regeneration device KG (in particular, the regeneration controller EG) via the communication bus BS. In the regeneration device KG, the generator GN is controlled by the regeneration controller EG such that the actual regeneration braking force Fg is close to and matches with the target regeneration braking force Fh.
A “limit regeneration braking force Fx” is a maximum value (a limit value) of the regeneration braking force Fg that can be generated by the regeneration device KG. Therefore, the regeneration device KG can generate the regeneration braking force Fg in a range from “Fg=0” to the limit regeneration braking force Fx. The limit regeneration braking force Fx is calculated by the regeneration device KG (in particular, the regeneration controller EG), and is transmitted to the upper braking unit SA (in particular, the upper controller EA) via the communication bus BS. The upper controller EA grasps an operation state of the regeneration device KG based on the limit regeneration braking force Fx.

In the pressure adjustment control, the second operation mode Ms is adopted as an operation mode of the braking operation member BP. For example, the operation mode of the braking operation member BP is switched from the first operation mode Mm to the second operation mode Ms when the braking control device SC is activated (or when braking is started).

In the second operation mode Ms, electric power is supplied to the introduction valve VA and the release valve VB, the normally close type introduction valve VA is opened, and the normally open type release valve VB is closed. In the second operation mode Ms, since the braking operation member BP can be displaced separately from the master piston NM, the front wheel and rear wheel pressures Pwf and Pwr can be adjusted independently of an operation of the braking operation member BP. In this case, the operation force Fp of the braking operation member BP is generated by the stroke simulator Ss.

In step S110, the upper and lower controllers EA and EZ read various signals. The upper controller EA acquires the braking operation amount Ba (a generic term for Sp and Pn), the target acceleration Gs, the detected servo pressure Pak, the detected supply pressure Psk, and the limit regeneration braking force Fx. The braking operation amount Ba and the target acceleration Gs are referred to as a “braking request amount Bs”. The braking request amount Bs is a state quantity representing a braking request to the vehicle, and is a generic term for the braking operation amount Ba and the target acceleration Gs.

In step S110, the lower controller EZ acquires the braking request amount Bs (a generic term of Ba and Gs), the target supply pressure Pst, and the first and second appropriateness flags FL and FM. The “target supply pressure Pst” is a target value corresponding to the supply pressure Ps. The “first appropriateness flag FL” is a control flag indicating whether an operation of the hydraulic pressure generation unit PU is normal or abnormal. For example, “FL=0” is determined when the hydraulic pressure generation unit PU is normal, and “FL=1” is determined when the hydraulic pressure generation unit PU is abnormal. The “second appropriateness flag FM” is a control flag indicating whether an operation of the upper braking unit SA is normal or abnormal. For example, “FM=0” is determined when the upper braking unit SA is normal, and “FM=1” is determined when the upper braking unit SA is abnormal. The target supply pressure Pst and the first and second appropriateness flags FL and FM are transmitted from the upper controller EA to the communication bus BS.

In step S120, the target total braking force Fv (a target value of the vehicle body total braking force Fu acting on the entire vehicle) is calculated based on the braking request amount Bs and a calculation map Zfv. The target total braking force Fv is calculated to “0” according to the calculation map Zfv when the braking request amount Bs is less than a predetermined amount bo. When the braking request amount Bs is equal to or larger than the predetermined amount bo, the calculation is made such that the target total braking force Fv increases from “0” as the braking request amount Bs increases. Here, the “predetermined amount bo” corresponds to the operation of the braking operation member BP or the like, and is set in advance as a predetermined value (a constant value) (see a total braking force calculation block FV).

In step S130, in order to perform the regenerative cooperation control, the target regeneration braking force Fh and the target friction braking force En are calculated based on the target total braking force Fv and the limit regeneration braking force Fx. Specifically, the target regeneration braking force Fh is determined to be equal to or less than the limit regeneration braking force Fx. For example, when the target vehicle body braking force Fv is equal to or less than the limit regeneration braking force Fx, the target regeneration braking force Fh is made equal to the target vehicle body braking force Fv, and the target friction braking forces Fn is determined to “0” (that is, when “FV<Fx”, “Fh=Fv, Fn=0”). When the target vehicle body braking force Fv is larger than the limit regeneration braking force Fx, the target regeneration braking force Fh is made equal to the limit regeneration braking force Fx, and the target friction braking force Fn is determined to be a “value obtained by subtracting the limit regeneration braking force Fx (=Fh) from the target vehicle body braking force Fv” (that is, when “Fv>Fx”, “Fh=Fx, Fn=Fv−Fx=Fv−Fh”). The target regeneration braking force Fh is transmitted from the upper controller EA to the regeneration controller EG via the communication bus BS. The regeneration controller EG controls the generator GN such that the actual regeneration braking force Fg is close to and matches with the target regeneration braking force Fh.

In step S140, a target servo pressure Pat is calculated based on the target friction braking force Fn. The “target servo pressure Pat” is a target value corresponding to the servo pressure Pa (an actual value). The target servo pressure Pat is converted from the target friction braking force Fn based on specifications of the braking device SX. Further, since the servo pressure Pa is transmitted to the wheel cylinder CW via the master cylinder CM, a sliding resistance of the seal member SL is considered in the calculation of the target servo pressure Pat. The specifications of the braking device SX include a pressure receiving area of the wheel cylinder CW, an effective braking radius of a rotating member KT (a brake disc), a friction coefficient of a friction member (a brake pad), and an effective radius of a wheel WH (a tire).

In step S150, it is determined whether “the hydraulic pressure generation unit PU is abnormal”. That is, in step S150, it is determined whether “the servo pressure Pa generated by the hydraulic pressure generation unit PU is insufficient or sufficient”. The processing of step S150 is referred to as the “first appropriateness determination”. When the first appropriateness determination is negative (that is, when the hydraulic pressure generation unit PU is normal and a sufficient servo pressure Pa is generated), the first appropriateness flag FL is set to “0”, and the processing proceeds to step S160. On the other hand, when the first appropriateness determination is affirmative (that is, when the hydraulic pressure generation unit PU fails and the servo pressure Pa is insufficient), the first appropriateness flag FL is set to “1”, and the processing proceeds to step S200. A case where the first appropriateness determination is affirmative is referred to as a “first abnormality”.

In step S160, it is determined whether “the upper braking unit SA is abnormal”. That is, in step S160, it is determined whether “the supply pressure Ps output from the upper braking unit SA is insufficient or sufficient”. The processing of step S160 is referred to as the “second appropriateness determination”. When the second appropriateness determination is negative (that is, when the upper braking unit SA is normal and a sufficient supply pressure Ps is output), the second appropriateness flag FM is set to “0”, and the processing proceeds to step S170. On the other hand, when the second appropriateness determination is affirmative (that is, when the upper braking unit SA fails and the supply pressure Ps is insufficient), the second appropriateness flag FM is set to “1”, and the processing proceeds to step S230. A case where the second appropriateness determination is affirmative is referred to as a “second abnormality”.

When the first abnormality is determined, the hydraulic pressure generation unit PU which is a pressurizing source (a power source) of the upper braking unit SA is abnormal, and thus the upper braking unit SA is naturally abnormal. That is, the first abnormality is a state in which the supply pressure Ps cannot be generated because the servo pressure Pa cannot be sufficiently generated. On the other hand, when the second abnormality is determined, the hydraulic pressure generation unit PU is normal, but the upper braking unit SA is abnormal. That is, the second abnormality is a state in which the servo pressure Pa is appropriately generated but the supply pressure Ps is not sufficiently generated. Details of the first and second appropriateness determination will be described later.

### <<Normal Control>>

When the upper braking unit SA including the hydraulic pressure generation unit PU operates normally, the processing in steps S170 to S190 is executed. The processing is referred to as “normal control”. In the normal control, the upper controller EA drives the upper actuator YA (in particular, the hydraulic pressure generation unit PU) in step S170. Accordingly, the servo pressure Pa is controlled to be close to and match with the target servo pressure Pat.

Specifically, first, the electric motor MA is driven. Accordingly, the circulation flow KN including the fluid pump QA and the pressure adjustment valve UA is generated. The target rotation speed Nt of the electric motor MA is calculated based on the operation speed dS. Then, a current Im supplied to the electric motor MA (a motor current) is controlled such that the motor rotation speed Na is close to and matches with the target rotation speed Nt.

Next, based on the target servo pressure Pat, the pressure adjustment valve UA is controlled such that the servo pressure Pa (an actual value) is close to and matches with the target servo pressure Pat (a target value). For example, based on the detected servo pressure Pak detected by the servo pressure sensor PA, control is performed such that the detected servo pressure Pak (a detected value) is close to and matches with the target servo pressure Pat (a target value). Since the servo pressure Pa and the pressure adjustment valve current Ia have a unique relationship, a target current Iat is calculated based on the target servo pressure Pat. Then, the drive circuit DR is controlled such that the pressure adjustment valve current Ia (a detected value) detected by the pressure adjustment valve current sensor is close to and matches the target current Iat (a target value). Further, the pressure adjustment valve current Ia is finely adjusted based on the detected servo pressure Pak so as to compensate for a hydraulic pressure error. That is, so-called hydraulic pressure feedback control (a closed loop control) is performed in the adjustment of the servo pressure Pa. Further, since the servo pressure Pa and the supply pressure Ps have a predetermined relationship (a relationship of “Pa=Ps” if the sliding resistance of the seal member SL is ignored), the detected supply pressure Psk (a detected value) detected by the supply pressure sensor PS may be controlled to be close to and match with the target servo pressure Pat in the feedback control.

In step S180, the second operation mode Ms continues to be selected as the operation mode in the input unit NR. Accordingly, the operation force Fp is generated by the stroke simulator SS, and the supply pressure Ps is controlled separately from the operation displacement Sp. In step S190, the lower actuator YZ is stopped. Therefore, a state of “Pa=Pm=Ps=Pw” continues.

### <<First Abnormality Control>>

When an abnormality of the hydraulic pressure generation unit PU is determined in the first appropriateness determination in step S150 (that is, when the servo pressure Pa is insufficient), processing in steps S200 to S220 is executed. The processing is referred to as “first abnormality control”. In the first abnormality control, an operation of the regeneration device KG is stopped in step S200. For example, “Fh=0” or “FL=1” is transmitted from the upper controller EA to the regeneration controller EG, and in the regeneration device KG, power generation by the generator GN is stopped. Accordingly, the regeneration braking force Fg is set to “0”, and the regenerative cooperation control is ended. Since the operation of the regeneration device KG is stopped, the target friction braking force Fn is made equal to the target vehicle body braking force Fv (that is, “Fn=Fv”). In step S200, the hydraulic pressure generation unit PU is stopped. Therefore, the servo pressure Pa is set to “0”.

In step S210, the first operation mode Mm is selected as the operation mode in the input unit NR. That is, power supply to the electromagnetic valves VA and VB is stopped, and the input chamber Rn is fluidly locked. Accordingly, the master piston NM and the braking operation member BP are integrally displaced, and the supply pressure Ps is generated by an operation of the braking operation member BP. That is, the supply pressure Ps (=Pm) from the upper braking unit SA is generated by a muscle strength of a driver (that is, the operation force Fp). In this case, the operation force Fp of the braking operation member BP is generated by rigidity (that is, elastic deformation of a brake caliper, a friction member, a braking pipe, and the like) of the braking device SX (a device that generates the friction braking force Fe by the wheel pressure Pw).

In step S220, complementary control is performed by the lower braking unit SZ to compensate for the shortage of the supply pressure Ps relative to the target supply pressure Pst and reduce the operation force Fp by the driver. The complementary control is started in response to “FL=1”. In the complementary control, a target supply pressure Pst that is a target value of the supply pressure Ps to be supplied to the lower braking unit SZ is calculated. The target supply pressure Pst is determined by compensating for an amount of the sliding resistance of the seal member SL with respect to the target servo pressure Pat. Since the target servo pressure Pat is calculated based on the braking request amount Bs, the target supply pressure Pst may be determined based on the braking request amount Bs (a generic term of Ba and Gs). Here, the target supply pressure Pst is calculated by the upper controller EA and acquired by the lower controller EZ. Alternatively, the lower controller EZ may perform the calculation based on a method similar to that of the upper controller EA.

Based on the target supply pressure Pst and the detected supply pressure Psk (=Pskf), a deviation hPs (also referred to as a “supply pressure deviation”) is calculated. Specifically, the supply pressure deviation hPs is determined by subtracting the detected supply pressure Psk from the target supply pressure Pst (that is, “hPs=Pst−Psk”). The supply pressure deviation hPs represents a shortage of the supply pressure Ps to be output from the upper actuator YA.

The lower actuator YZ (MZ, UZ, and the like) is driven based on the supply pressure deviation hPs. The electric motor MZ is driven, and the braking fluid BF is discharged from the fluid pump QZ. Accordingly, the circulation flow KZ of the braking fluid BF is generated in the communication passage HS and the return passage HZ. A target current Is is calculated based on the supply pressure deviation hPs and a preset calculation map (not illustrated). The “target current Is” is a target value corresponding to the current Iz supplied to the control valve UZ (the control valve current). The target current Is is determined according to the calculation map such that the target current Is increases as the supply pressure deviation hPs increases. The drive signal Uz is calculated such that the control valve current Iz (a detected value) is close to and matches with the target current Is (target value). Here, the control valve current Iz is detected by a control valve current sensor (not illustrated) provided in the drive circuit DR of the lower controller EZ.

By throttling the circulation flow KZ by the control valve UZ, the adjustment pressure Pp (=Pw) is increased from the supply pressure Ps by an amount corresponding to the supply pressure deviation hPs. The increased adjustment pressure Pp (=Pw) is output from the lower actuator YZ as the wheel pressure Pw (an actual value) (that is, “Pw=Ps+hPs”).

In the case of the first abnormality in which the servo pressure Pa is insufficient, the hydraulic pressure generation unit PU is stopped, and the first operation mode Mm is selected. The supply pressure Ps (=Pm) is generated only by the operation force Fp of the braking operation member BP operated by the driver. However, in the braking control device SC, the wheel pressure Pw corresponding to the braking request amount Bs can be generated by the complementary control in the lower braking unit SZ. This compensates for the shortage of the supply pressure Pa and reduces the operation force Fp.

### <<Second Abnormality Control>>

When the first appropriateness determination in step S150 is negative but the second appropriateness determination in step S160 is affirmative (that is, when the servo pressure Pa is sufficient but the supply pressure Ps is insufficient), the processing in steps S230 to S250 is executed. The processing is referred to as “second abnormality control”. In the second abnormality, the hydraulic pressure generation unit PU is normal, but the upper braking unit SA is abnormal. In this situation, an abnormality occurs in a hydraulic pressure transmission passage from the hydraulic pressure generation unit PU to the lower braking unit SZ. For example, such an abnormality occurs when a sliding resistance in the seal member SL of the master cylinder CM increases, when a resistance in a fluid passage increases, or the like.

In the second abnormality control, an operation of the hydraulic pressure generation unit PU continues in step S230, which is similar to step S170. In step S240, the second operation mode Ms is selected in the input unit NR, which is similar to step S180. In step S250, the complementary control is performed by the lower braking unit SZ, which is similar to step S220. Since the complementary control is the same as described above, the description thereof will be omitted. When the hydraulic pressure generation unit PU is normal but the desired supply pressure Ps is not output from the upper braking unit SA for some reason (that is, at the time of the second abnormality), the complementary control is performed in the lower braking unit SZ while the same operation as the normal control (continuation of the hydraulic pressure generation unit PU and the second operation mode Ms) is performed. Accordingly, since an operation feature (an Sp-Fp feature) of the braking operation member BP is not changed, the driver is prevented from feeling uncomfortable. Further, since the shortage of the supply pressure Ps is compensated by the complementary control, a sufficient vehicle deceleration is ensured.

In the case of the second abnormality in which the servo pressure Pa is sufficient but the supply pressure Ps is insufficient, performance and a feature which are not changed from those in the normal control are ensured by the continuation of the operation of the hydraulic pressure generation unit PU, the selection of the second operation mode Ms, and the complementary control in the lower braking unit SZ. Therefore, even in the second abnormality, the regenerative cooperation control can continue. However, the regenerative cooperation control may be stopped because of an abnormal state. That is, in the regenerative cooperation control in the second abnormality, any one of a configuration in which the regeneration device KG continues to operate and a configuration in which the regeneration device KG is stopped may be selected. In the configuration in which the regeneration device KG is stopped, “Fh=0” or “FM=1” is transmitted from the upper controller EA to the regeneration controller EG.

In the braking control device SC, the presence or absence of a device abnormality is executed in two stages. Specifically, the first appropriateness determination for determining an abnormality of the hydraulic pressure generation unit PU and the second appropriateness determination for determining an abnormality of the upper braking unit SA are performed. A device abnormality occurs not only in a power source such as the electric motor MA but also in a hydraulic pressure transmission passage. In the braking control device SC, since the abnormality is doubly identified, reliability is improved, and a portion where the abnormality occurs is identified. Therefore, an abnormality countermeasure can be appropriately selected according to an abnormal portion. That is, the abnormality is appropriately handled.

In the braking control device SC, a service brake (also referred to as a “regular brake”) is executed using the hydraulic pressure generation unit PU as a power source. That is, when the braking control device SC is normal and the anti-lock brake control, the traction control, the side slip prevention control, and the like are not performed, the lower actuator YZ (particularly, the electric motor MZ and the control valve UZ) is stopped, and only the upper braking unit SA is operated. When the hydraulic pressure generation unit PU cannot appropriately generate the servo pressure Pa (that is, when the first abnormality is determined), the hydraulic pressure generation unit PU is stopped. This is because the servo pressure Pa cannot be appropriately obtained even when electric power is supplied to the hydraulic pressure generation unit PU at the time of the first abnormality. At this time, the operation mode of the braking operation member BP is set to the first operation mode Mm, and the supply pressure Ps (=Pm) is generated using the muscle strength of the driver as a power source. Further, the supply pressure Ps is amplified by the complementary control in the lower braking unit SZ to generate the wheel pressure Pw. Accordingly, the operation force Fp by the driver is reduced, and a vehicle deceleration is ensured.

On the other hand, when the hydraulic pressure generation unit PU operates normally but the supply pressure Ps is not appropriately output from the upper braking unit SA (that is, when the second abnormality is determined), the hydraulic pressure generation unit PU is operated. The second abnormality occurs in a situation in which a resistance in a hydraulic pressure transmission passage increases, but in the second abnormality in which the hydraulic pressure generation unit PU operates normally, an abnormal state may be eliminated. Therefore, the hydraulic pressure generation unit PU is not stopped, and an operation thereof continues. At this time, the operation mode of the braking operation member BP is set to the second operation mode Ms, and an operation feature thereof is not changed. The decrease in the supply pressure Ps is compensated by the complementary control in the lower braking unit SZ. Accordingly, the driver is prevented from feeling uncomfortable, and the vehicle deceleration is ensured.

### <Processing of First and Second Appropriateness Determination>

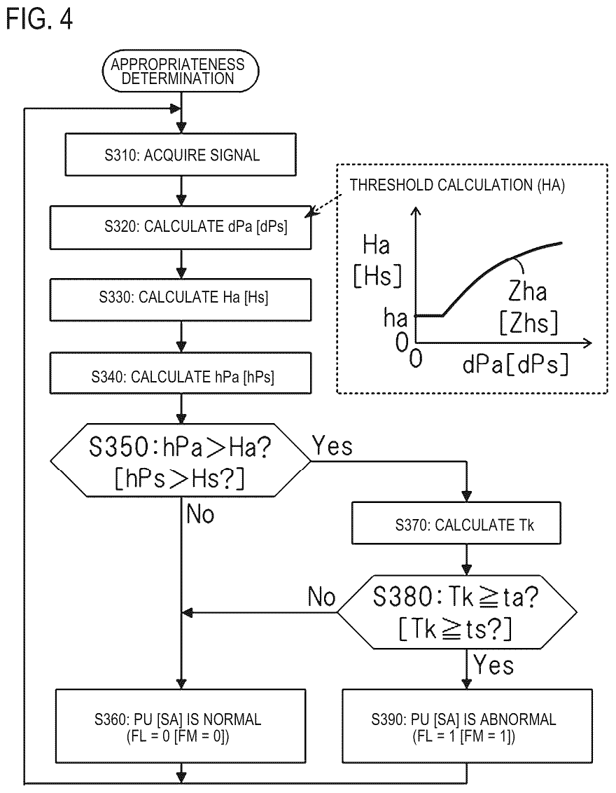

The first and second appropriateness determination processing (processing in steps S150 and S160) will be described with reference to the flowchart in FIG. 4. In the first appropriateness determination, “whether the operation of the hydraulic pressure generation unit PU is abnormal (that is, whether the servo pressure Pa is sufficient)” is determined. In the second appropriateness determination, “whether the operation of the upper braking unit SA is abnormal (that is, whether the supply pressure Ps is sufficient)” is determined. The first and second appropriateness determination is also referred to as “first and second abnormality determination”. In the first and second appropriateness determination, state quantities used therein are different, but the processing is basically the same. The first and second appropriateness determination is performed by the upper controller EA.

### <<First Appropriateness Determination>>

The first appropriateness determination for identifying the shortage of the servo pressure Pa is performed based on a deviation hPa between the target servo pressure Pat and the detected servo pressure Pak (referred to as a “servo pressure deviation”).

In step S310, the target servo pressure Pat and the detected servo pressure Pak are read. The target servo pressure Pat is a target value related to the servo pressure Pa calculated based on the braking request amount Bs. The detected servo pressure Pak is a detection result of the servo pressure sensor PA.

In step S320, a target servo pressure gradient dPa is calculated based on the target servo pressure Pat. The “target servo pressure gradient dPa” is a value corresponding to a change amount of the target servo pressure Pat per unit time (also simply referred to as a “time change amount”). For example, an absolute value of the target servo pressure Pat is time-differentiated to determine the target servo pressure gradient dPa (a time change amount related to the servo pressure Pa). Since the target servo pressure Pat is calculated based on the braking request amount Bs, the target servo pressure gradient dPa may be calculated based on the braking request amount Bs. When the target servo pressure Pat is maintained constant, the target servo pressure gradient dPa is “0”.

In step S330, a first threshold pressure Ha is calculated based on the target servo pressure gradient dPa. The “first threshold pressure Ha” is a threshold for determining an abnormality of the hydraulic pressure generation unit PU. The first threshold pressure Ha is determined according to a preset calculation map Zha such that the first threshold pressure Ha increases as the target servo pressure gradient dPa increases. That is, when the target servo pressure gradient dPa is large, the first threshold pressure Ha is made larger than that in a case where the target servo pressure gradient dPa is small. A lower limit pressure ha is set for the first threshold pressure Ha. The lower limit pressure ha is a predetermined value (a constant) set in advance (see a threshold pressure calculation block HA of a blowing portion).

The braking control device SC is a so-called on-demand device that operates in response to a braking request. Therefore, the hydraulic pressure generation unit PU is stopped during non-braking. Then, an operation of the hydraulic pressure generation unit PU starts in response to the start of braking. Since responsiveness of the hydraulic pressure generation unit PU (particularly, the electric motor MA) is limited, the servo pressure deviation hPa may instantaneously increase when the hydraulic pressure generation unit PU is activated. In such a situation, the first threshold pressure Ha is determined based on the target servo pressure gradient dPa so that an abnormality is not determined unnecessarily. That is, when the target servo pressure gradient dPa is large, the first threshold pressure Ha is determined to be large, so that unnecessary determination of an abnormality is avoided.

In step S340, the deviation hPa (a servo pressure deviation) is calculated based on the target servo pressure Pat and the detected servo pressure Pak. Specifically, the servo pressure deviation hPa is determined by subtracting the detected servo pressure Pak from the target servo pressure Pat (that is, “hPa=Pat−Pak”). The servo pressure deviation hPa represents a shortage of the detected servo pressure Pak relative to the target servo pressure Pat.

In step S350, it is determined whether “the servo pressure deviation hPa is larger than the first threshold pressure Ha”. When the servo pressure deviation hPa is less than or equal to the first threshold pressure Ha, a negative determination is made in step S350, and the processing proceeds to step S360. In step S360, the hydraulic pressure generation unit PU is identified as normal, and the first appropriateness flag FL is set to “0”. On the other hand, when the servo pressure deviation hPa is larger than the first threshold pressure Ha, an affirmative determination is made in step S350, and the processing proceeds to step S370.

In step S370, a duration Tk is calculated. The duration Tk is a time during which a state of “hPa>Ha” continues. In other words, the duration Tk is an elapsed time from a time point when the affirmative determination is made in step S350 for the first time.

In step S380, it is determined whether “the duration Tk is longer than a first predetermined time ta” based on the duration Tk. Here, the “first predetermined time ta” is a threshold related to the duration Tk and is a predetermined value (a constant) set in advance. When the duration Tk is equal to or less than the first predetermined time ta and the determination in step S380 is negative, the processing proceeds to step S360. On the other hand, when the duration Tk exceeds the first predetermined time ta and the determination in step S380 is affirmative, the processing proceeds to step S390. In step S390, an abnormality of the hydraulic pressure generation unit PU (that is, the first abnormality) is identified, and the first appropriateness flag FL is set to “1”.

In the first appropriateness determination (the first abnormality determination), even when the servo pressure deviation hPa exceeds the first threshold pressure Ha, the abnormality of the hydraulic pressure generation unit PU is not immediately determined. When a state in which the servo pressure deviation hPa is larger than the first threshold pressure Ha continues for the first predetermined time ta, the abnormality of the hydraulic pressure generation unit PU is determined. In the lower braking unit SZ, the execution of the complementary control is started by switching the first appropriateness flag FL from “0” to “1”.

### <<Second Appropriateness Determination>>

The second appropriateness determination for identifying the shortage of the supply pressure Ps is performed based on a deviation hPs between the target supply pressure Pst and the detected supply pressure Psk (referred to as a “supply pressure deviation”). The description of the second appropriateness determination corresponds to a case where the “target servo pressure Pat” is replaced with the “target supply pressure Pst”, the “detected servo pressure Pak” is replaced with the “detected supply pressure Psk”, the “servo pressure deviation hPa” is replaced with the “supply pressure deviation hPs”, the “target servo pressure gradient dPa” is replaced with a “target supply pressure gradient des”, the “calculation map Zha” is replaced with a “calculation map Zhs”, the “first threshold pressure Ha” is replaced with a “second threshold pressure Hs”, the “first predetermined time ta” is replaced with a “second predetermined time ts”, and the “first appropriateness flag FL” is replaced with the “second appropriateness flag FM” in the description of the first appropriateness determination. Further, symbols in square brackets in FIG. 4 correspond to the second appropriateness determination. Hereinafter, the processing of the second appropriateness determination will be briefly described.

In step S310, the target supply pressure Pst and the detected supply pressure Psk are read. The target supply pressure Pst is a target value related to the supply pressure Ps, and the detected supply pressure Psk is a detection result of the supply pressure sensor PS. In step S320, the target supply pressure gradient dPs is calculated based on the target supply pressure Pst. The “target supply pressure gradient des” is a value corresponding to a change amount per unit time of the target supply pressure Pst (an absolute value). When the target supply pressure Pst is constant, the target supply pressure gradient des is determined to be “0”. In step S330, the second threshold pressure Hs is calculated based on the target supply pressure gradient dPs (the time change amount related to the supply pressure Ps). The “second threshold pressure Hs” is a threshold for determining an abnormality of the upper braking unit SA. The second threshold pressure Hs is determined according to the preset calculation map Zhs such that the second threshold pressure Hs increases as the target supply pressure gradient dPs increases. Similar to the above, the second threshold pressure Hs is determined based on the target supply pressure gradient dPs in order to avoid unnecessary abnormality determination. The second threshold pressure Hs is also provided with a lower limit pressure that is a predetermined value (a constant) set in advance.

In step S340, the deviation hPs between the target supply pressure Pst and the detected supply pressure Psk (the supply pressure deviation) is calculated (that is, “hPs=Pst−Psk”). The supply pressure deviation hPs is a shortage of the detected supply pressure Psk relative to the target supply pressure Pst. In step S350, it is determined whether “the supply pressure deviation hPs is larger than the second threshold pressure Hs”. When the supply pressure deviation hPs is equal to or less than the second threshold pressure Hs, a negative determination is made in step S350, and the processing proceeds to step S360. In step S360, the upper braking unit SA is identified as normal, and the second appropriateness flag FM is set to “0”. On the other hand, when the supply pressure deviation hPs is larger than the second threshold pressure Hs, an affirmative determination is made in step S350, and the processing proceeds to step S370.

In step S370, the duration Tk is calculated. The duration Tk is a time during which a state of “hPs>Hs” continues. In step S380, it is determined whether “the duration Tk is longer than the second predetermined time ts” based on the duration Tk. Here, the “second predetermined time ts” is a predetermined value (a constant) set in advance. When the duration Tk is equal to or less than the second predetermined time ts and the determination in step S380 is negative, the processing proceeds to step S360. On the other hand, when the duration Tk exceeds the second predetermined time ts and the determination in step S380 is affirmative, the processing proceeds to step S390. In step S390, an abnormality of the upper braking unit SA (that is, the second abnormality) is identified, and the second appropriateness flag FM is set to “1”.

In a relationship between the first appropriateness determination and the second appropriateness determination, the first and second threshold pressures Ha and Hs are determined such that a situation in which the first appropriateness determination is affirmative and the second appropriateness determination is negative does not occur. Since “rc=rm” in the braking control device SC, the supply pressure Ps (=Pm) is smaller than the servo pressure Pa by a hydraulic pressure corresponding to the sliding resistance of the seal member SL at the time of a pressure increase. Therefore, the second threshold pressure Hs is set to a value equal to or higher than the first threshold pressure Ha. When the servo pressure deviation hPa is larger than the first threshold pressure Ha, the supply pressure deviation hPs is constantly larger than the second threshold pressure Hs, so that the above situation is reliably avoided.

Since the first appropriateness determination is performed based on the servo pressure deviation hPa, not only a simple functional failure but also an abnormality related to an output decrease of the hydraulic pressure generation unit PU can be identified. Similarly, since the second appropriateness determination is performed based on the supply pressure deviation hPs, an output decrease of the entire upper braking unit SA can be determined.

### <Operations of First and Second Appropriateness Determination>

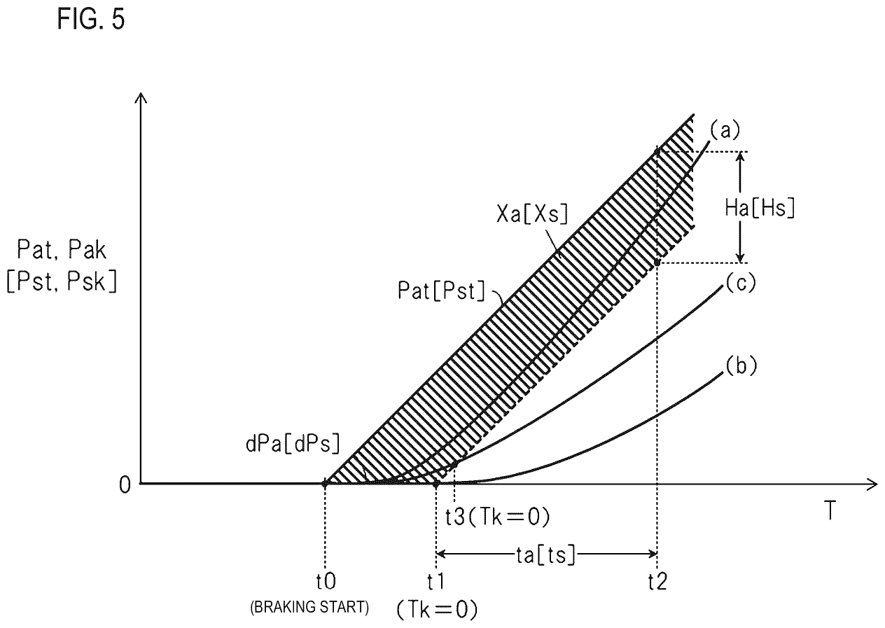

Operations of the first and second appropriateness determination will be described with reference to a time series diagram in FIG. 5 (a transition diagram of state quantities over a time T).

### <<First Appropriateness Determination>>

The appropriateness (a normality or an abnormality) of the hydraulic pressure generation unit PU in the first appropriateness determination is determined based on the target servo pressure Pat (a target value) and the detected servo pressure Pak (a detected value of the servo pressure sensor PA). In the first appropriateness determination, the hydraulic pressure generation unit PU is determined as normal when “(Pat−Pak)≤Ha”, and the hydraulic pressure generation unit PU is determined as abnormal when “(Pat−Pak)>Ha”.

“Pak≥(Pat−Ha)” is obtained by modifying “(Pat−Pak)≤Ha”. Therefore, the first appropriateness determination can be expressed as follows. Assuming a hydraulic pressure obtained by subtracting the first threshold pressure Ha from the target servo pressure Pat is a “first lower limit pressure”, the hydraulic pressure generation unit PU is normal when the detected servo pressure Pak is equal to or higher than the first lower limit pressure “Pat−Ha”. Here, a region from the target servo pressure Pat to the first lower limit pressure “Pat Ha” is referred to as a “first allowable range Xa”. In the appropriateness determination, the first allowable range Xa is determined (set) based on the target servo pressure Pat and the first threshold pressure Ha. When the detected servo pressure Pak transitions within the first allowable range Xa, it is determined that the hydraulic pressure generation unit PU is normal. On the other hand, when the detected servo pressure Pak transitions out of the first allowable range Xa, it is determined that the hydraulic pressure generation unit PU is abnormal.

The first appropriateness determination is constantly executed when the hydraulic pressure generation unit PU is operated (that is, when the servo pressure Pa is increased, maintained, or decreased). Alternatively, the appropriateness determination may be executed only when a pressure is increased in the hydraulic pressure generation unit PU. In this case, a value corresponding to an increase amount of the target servo pressure Pat per unit time (a time change amount when the hydraulic pressure increases) is adopted as the target servo gradient dPa. In any case, the operation of the hydraulic pressure generation unit PU is constantly monitored not only at the time of activation but also at least when the servo pressure Pa increases.

FIG. 5 illustrates the first appropriateness determination when the target servo pressure Pat increases at a constant target servo pressure gradient dPa over a time T. A hatched region is set as the first allowable range Xa. The first threshold pressure Ha changes according to the target servo pressure gradient dPa, and the first threshold pressure Ha is a constant value in this example. Three examples (a), (b), and (c) of the transition of the detected servo pressure Pak are illustrated.

At a time point to, braking is started, and the braking request amount Bs increases from “0”. Accordingly, the target servo pressure Pat increases from “0”. Immediately after the time point to, the target servo pressure gradient dPa (a change amount of the target servo pressure Pat per unit time) is calculated based on the target servo pressure Pat (an absolute value). Then, the first threshold pressure Ha is determined based on the target servo pressure gradient dPa. The first threshold pressure Ha is calculated to be larger as the target servo pressure gradient dPa becomes larger. The first threshold pressure Ha is compared with the deviation hPa between the target servo pressure Pat and the detected servo pressure Pak (a detected value of the servo pressure sensor PA). That is, it is determined whether the detected servo pressure Pak is within the first allowable range Xa.

### Transition Example (a)

As in the transition example (a), when the detected servo pressure Pak increases from “0” within the first allowable range Xa and then transitions within the first allowable range Xa, a state in which the servo pressure deviation hPa is equal to or less than the first threshold pressure Ha continues. That is, since the detected servo pressure Pak follows the target servo pressure Pat, a negative determination is made in step S250, and it is continuously determined that “the hydraulic pressure generation unit PU is normal (FL=0)”.

### Transition Example (b)

As in the transition example (b), when the detected servo pressure Pak does not increase from “0” within the first allowable range Xa (that is, when the rising of the detected servo pressure Pak is delayed), counting of the duration Tk is started at a time point t1 when the detected servo pressure Pak transitions out of the first allowable range Xa. Thereafter, a state in which the detected servo pressure Pak is out of the first allowable range Xa (that is, a state in which the servo pressure deviation hPa is larger than the first threshold pressure Ha) continues for the first predetermined time ta. At a time point t2, a positive determination is made in step S380, and it is determined that “the hydraulic pressure generation unit PU is abnormal (FL=1)”. At the time point t2, electric power supplied to the hydraulic pressure generation unit PU is stopped, and the hydraulic pressure generation unit PU is stopped. Further, at the time point t2, electric power supplied to the electromagnetic valves VA and VB is stopped, and the operation mode is switched from the second operation mode Ms to the first operation mode Mm.

### Transition Example (c)

As in the transition example (c), the detected servo pressure Pak increases from “0” within the first allowable range Xa, but then transitions out of the first allowable range Xa. The duration Tk is calculated from a time point t3 at which the detected servo pressure Pak transitions out of the first allowable range Xa. Similar to the transition example (b), when a state in which the detected servo pressure Pak transitions out of the first allowable range Xa (that is, a state of “hPa>Ha”) continues for the first predetermined time ta, the hydraulic pressure generation unit PU is determined as abnormal. Then, the above-described abnormality countermeasure (stopping of the hydraulic pressure generation unit PU and switching to the first operation mode Mm) is made.

Even when the detected servo pressure Pak once transitions out of the first allowable range Xa, the calculation of the duration Tk is reset and returned to “Tk=0” when the detected servo pressure Pak enters the first allowable range Xa. Thereafter, when the detected servo pressure Pak transitions out of the first allowable range Xa again, counting of the duration Tk is started from that time point.

### <<Second Appropriateness Determination>>

The appropriateness (a normality or an abnormality) of the upper braking unit SA in the second appropriateness determination is determined based on the target supply pressure Pst (a target value) and the detected supply pressure Psk (a detected value of the supply pressure sensor PS). In the second appropriateness determination, the upper braking unit SA is determined as normal in a case of “(Pst−Psk)≤Hs”.

Similar to the above, symbols in square brackets in FIG. 5 correspond to the second appropriateness determination. The description of the second appropriateness determination corresponds to a case where the “target servo pressure Pat” is replaced with the “target supply pressure Pst”, the “detected servo pressure Pak” is replaced with the “detected supply pressure Psk”, the “servo pressure deviation hPa” is replaced with the “supply pressure deviation hPs”, the “target servo pressure gradient dPa” is replaced with the “target supply pressure gradient dps”, the “calculation map Zha” is replaced with the “calculation map Zhs”, the “first threshold pressure Ha” is replaced with the “second threshold pressure Hs”, the “first predetermined time ta” is replaced with the “second predetermined time ts”, the “first appropriateness flag FL” is replaced with the “second appropriateness flag FM”, and the “first allowable range Xa” is replaced with the “second allowable range Xs” in the description of the first appropriateness determination. Hereinafter, an operation of the second appropriateness determination will be briefly described.

Assuming a hydraulic pressure obtained by subtracting the second threshold pressure Hs from the target supply pressure Pst is referred to as a “second lower limit pressure”, the upper braking unit SA is normal when the detected supply pressure Psk is equal to or higher than the second lower limit pressure “Pst−Hs”. Similarly, a region from the target supply pressure Pst to the second lower limit pressure “Pst−Hs” is referred to as the “second allowable range Xs”. In the second appropriateness determination, the second allowable range Xs is determined (set) based on the target supply pressure Pst and the second threshold pressure Hs. When the detected supply pressure Psk transitions within the second allowable range Xs, it is determined that the upper braking unit SA is normal. On the other hand, when the detected supply pressure Psk transitions out of the second allowable range Xs, it is determined that the upper braking unit SA is abnormal. Specifically, when a state in which the detected supply pressure Psk transitions out of the second allowable range Xs (that is, a state of “hPs>Hs”) continues for the second predetermined time ts, the upper braking unit SA is determined as abnormal.

Determination methods of the first and second appropriateness determination are similar. However, a countermeasure after an abnormality is determined in the second appropriateness determination is different from that in the first appropriateness determination. Even when an abnormality is determined in the second appropriateness determination, the operation of the hydraulic pressure generation unit PU continues, and the second operation mode Ms continues. However, the complementary control in the lower braking unit SZ is also performed in the second abnormality in a similar manner to the first abnormality.

### Other Embodiments of Braking Control Device SC

Hereinafter, other embodiments of the braking control device SC will be described. In other embodiments, the same effects as those described above (improvement in reliability of abnormality determination, identification of an abnormality occurrence portion, a corresponding countermeasure, and the like) are achieved.

In the above embodiment, the first threshold pressure Ha is determined based on the servo pressure gradient dPa corresponding to a change amount per unit time of the servo pressure Pa, and the second threshold pressure Hs is determined based on the supply pressure gradient dPs corresponding to a change amount per unit time of the supply pressure Ps. There is a predetermined relationship between the servo pressure Pa and the supply pressure Ps. Therefore, the first and second threshold pressures Ha and Hs may be determined based on a change amount per unit time (also referred to as a “target gradient dPx”) of at least one of the servo pressure Pa and the supply pressure Ps. In other words, the target gradient dPx can be referred to as a generic term for the target servo pressure gradient dPa and the target supply pressure gradient dPs. For example, a larger one of the target servo pressure gradient dPa and the target supply pressure gradient dps is determined as the target gradient dPx. Alternatively, an average value of the target servo pressure gradient dPa and the target supply pressure gradient des may be determined as the target gradient dPx. In any case, in the upper braking unit SA, the first and second threshold pressures Ha and Hs are set according to the target gradient dPx calculated based on at least one of the servo pressure Pa and the supply pressure Ps. Here, the first and second threshold pressures Ha and Hs increase as the target gradient dPx increases.

In the above embodiment, the target values (Fv, Fx, Fh, Fn, and the like) of various braking forces are calculated in a dimension of a front-rear force acting on the vehicle. Alternatively, the calculation may be performed using a dimension of a deceleration of the vehicle or a dimension of a torque of the wheel WH. This is based on a matter that state quantities from the front-rear force to the deceleration of the vehicle (referred to as “force-related state quantities”) are equivalent. Therefore, the target servo pressure Pat and the target supply pressure Pst are calculated based on the state quantities related to forces from the front-rear force acting on the vehicle to the deceleration of the vehicle.

In the above embodiment, a front-rear type is adopted for a braking system including two systems. Alternatively, a diagonal type (also referred to as an “X type”) may be adopted for the braking system including two systems. In this configuration, one of the two master chambers Rm is connected to the left front wheel cylinder and the right rear wheel cylinder, and the other one of the two master chambers Rm is connected to the right front wheel cylinder and the left rear wheel cylinder.

In the above embodiment, the tandem type master cylinder CM is exemplified. Alternatively, a single type master cylinder CM may be adopted. In this configuration, the secondary master piston NS is omitted. One master chamber Rm is connected to four wheel cylinders CW. In this configuration, the supply pressure Ps (=Pm) is output from one master cylinder CM.

In a configuration in which the single-type master cylinder CM is adopted, the master chamber Rm may be connected to the front wheel cylinder CWf, and the servo pressure Pa may be directly supplied from the hydraulic pressure generation unit PU to the rear wheel cylinder CWr. In this configuration, the front wheel supply pressure Psf (=Pm) is output from the master cylinder CM. On the other hand, the rear wheel supply pressure Psr (=Pa) is output from the hydraulic pressure generation unit PU.

In the above embodiment, a hydraulic pressure generation unit (a so-called reflux type configuration) that adjusts the servo pressure Pa by throttling the circulation flow KN of the braking fluid BF discharged by the fluid pump QA with the pressure adjustment valve UA is exemplified as the hydraulic pressure generation unit PU. Alternatively, in the hydraulic pressure generation unit PU, a volume in a cylinder may be increased or decreased by a piston directly driven by an electric motor to adjust the servo pressure Pa (a so-called electric cylinder type configuration). Even in the electric cylinder type, the hydraulic pressure generation unit PU (particularly, the electric motor) operates when there is a braking request corresponding to the braking request amount Bs, which is similar to the reflux type. That is, the hydraulic pressure generation unit PU is an on-demand type.

In the above embodiment, the pressure receiving area rm (the master area) of the master chamber Rm and the pressure receiving area rc (the servo area) of the servo chamber Rc are set to be equal in the apply unit AP. The master area rm and the servo area rc may be not equal. In a configuration in which the master area rm and the servo area rc are different from each other, a hydraulic pressure can be converted based on a ratio of the servo area rc and the master area rm (also referred to as an “area ratio”). In this configuration, the first and second threshold pressures Ha and Hs are determined based on the area ratio so that a situation in which the first appropriateness determination is affirmative and the second appropriateness determination is negative does not occur. Further, conversion based on the area ratio is also performed in calculation of the target gradient dPx.

In the above embodiment, the supply pressure Ps is output via the master cylinder CM. That is, the apply unit AP and the hydraulic pressure generation unit PU are arranged in series in the hydraulic pressure transmission passage, and the servo pressure Pa supplied from the hydraulic pressure generation unit PU is generated as the supply pressure Ps via the master piston NM. Alternatively, the apply unit AP and the hydraulic pressure generation unit PU may be arranged in parallel. Specifically, each of the apply unit AP (particularly, the master cylinder CM) and the hydraulic pressure generation unit PU is directly connected to the lower actuator YZ. “Connection between the hydraulic pressure generation unit PU and the lower actuator YZ” is selected in the second operation mode Ms, and “connection between the apply unit AP and the lower actuator YZ” is selected in the first operation mode Mm. For example, the selection is implemented by an on-off electromagnetic valve (referred to as a “switching valve”). In the second operation mode Ms in this configuration, the servo pressure Pa generated by the hydraulic pressure generation unit PU is output as the supply pressure Ps without passing through the apply unit AP. In this case, since the apply unit AP is connected to the stroke simulator SS, the operation force Fp of the braking operation member BP is generated by the stroke simulator SS. On the other hand, in the first operation mode Mm, a hydraulic pressure Pm of the master chamber Rm (a master pressure) generated by an operation of the braking operation member BP is output as the supply pressure Ps. In this case, since the apply unit AP is disconnected from the stroke simulator SS, the operation force Fp is generated by rigidity of the braking device SX (elastic deformation of a brake caliper, a friction member, a braking pipe, and the like).

In the above embodiment, the regeneration device KG is provided in the front wheel WHf, and the regenerative cooperation control is applied to the vehicle. In the vehicle in which the regenerative cooperation control is performed, the regeneration device KG may be provided in at least one of the front wheels WHf and the rear wheels WHr. The braking control device SC can also be applied to a vehicle in which the regeneration device KG is omitted and the regenerative cooperation control is not performed. That is, the braking control device SC can be applied to various vehicles regardless of the presence or absence of the regenerative cooperation control.

### Summary of Embodiments

Hereinafter, embodiments of the braking control device SC will be summarized. The braking control device SC is a brake-by-wire device capable of independently adjusting the operation displacement Sp of the braking operation member BP and the hydraulic pressure Pw (the wheel pressure) of the wheel cylinder CW. The hydraulic pressure generation unit PU of the braking control device SC is an on-demand type and operates when there is a braking request corresponding to the braking request amount Bs (Sp or the like).

The braking control device SC controls the hydraulic pressure Pw (the wheel pressure) of the wheel cylinder CW by the hydraulic pressure generation unit PU controlled by the controller EA. Specifically, the braking control device SC includes the upper braking unit SA and the lower braking unit SZ. The upper braking unit SA outputs the supply pressure Ps to the lower braking unit SZ by matching the servo pressure Pa generated by the hydraulic pressure generation unit PU with the target servo pressure Pat calculated based on the operation amount Ba of the braking operation member BP. The lower braking unit SZ is disposed between the upper braking unit SA and the wheel cylinder CW.

The upper braking unit SA stops the hydraulic pressure generation unit PU in the case of the first abnormality in which the servo pressure Pa is insufficient. On the other hand, the upper braking unit SA continues the operation of the hydraulic pressure generation unit PU in the case of the second abnormality in which the servo pressure Pa is sufficient but the supply pressure Ps is insufficient. In the case of the first and second abnormality, the lower braking unit SZ increases the supply pressure Ps and outputs the increased supply pressure Ps to the wheel cylinder CW.

For example, the braking control device SC includes the servo pressure sensor PA that detects the servo pressure Pa as the detected servo pressure Pak and the supply pressure sensor PS that detects the supply pressure Ps as the detected supply pressure Psk. The upper braking unit SA sets the first allowable range Xa according to the target servo pressure Pat and the first threshold pressure Ha, and sets the second allowable range Xs according to the target supply pressure Pst corresponding to the supply pressure Ps and the second threshold pressure Hs. Then, the upper braking unit SA determines the first abnormality when the detected servo pressure Pak transitions out of the first allowable range Xa. Further, the upper braking unit SA determines the second abnormality when the detected servo pressure Pak transitions within the first allowable range Xa but the detected supply pressure Psk transitions out of the second allowable range Xs. Here, in the upper braking unit SA, the first and second threshold pressures Ha and Hs are determined such that the second abnormality is always affirmed when the first abnormality occurs.

In the upper braking unit SA, the first operation mode Mm is selected in the case of the first abnormality, and the second operation mode Ms is selected in the case of the second abnormality. In the first operation mode Mm, the operation amount Ba and the supply pressure Ps are linked, and the supply pressure Ps is generated using the operation force Fp (that is, the muscle strength of the driver) as a power source. In this case, the operation force Fp of the braking operation member BP is generated by the rigidity of the braking device SX. On the other hand, in the second operation mode Ms, the supply pressure Ps is generated using the hydraulic pressure generation unit PU as a power source. In this case, the operation amount Ba and the supply pressure Ps are independent, and the operation force Fp of the braking operation member BP is generated and applied by the stroke simulator ss.

In the upper braking unit SA of the braking control device SC, the abnormality determination of the hydraulic pressure generation unit PU and the abnormality determination of the entire upper braking unit SA are separately performed. That is, not only the monitoring of the hydraulic pressure generation unit PU which is a power source (that is, the first appropriateness determination) but also the monitoring of the hydraulic pressure transmission passage in the upper braking unit SA (that is, the second appropriateness determination) is performed. Since the abnormality monitoring is doubly performed, the reliability of the appropriateness determination is improved. In addition, an abnormal portion is specified by the two kinds of appropriateness determination, and different abnormality countermeasures are made. That is, in the braking control device SC, since a countermeasure is appropriately selected according to a portion where an abnormality occurs, it is possible to appropriately cope with the abnormality.

In the upper braking unit SA of the braking control device SC, the wheel pressure Pw is electrically generated by using the hydraulic pressure generation unit PU as a pressurizing source (a power source). In the case of the first abnormality (that is, when the hydraulic pressure generation unit PU is abnormal), since the upper braking unit SA cannot output the sufficient supply pressure Ps, the hydraulic pressure generation unit PU is stopped. Then, the operation mode is switched from the second operation mode Ms to the first operation mode Mm. Accordingly, the supply pressure Ps is generated by the muscle strength of the driver.

On the other hand, in the case of the second abnormality (that is, when the hydraulic pressure generation unit PU is normal but the upper braking unit SA is abnormal), since there is a possibility that the abnormality is resolved, the hydraulic pressure generation unit PU is operated, and the supply pressure Ps is generated by the servo pressure Pa. In this case, the operation mode remains as the second operation mode Ms. The driver is prevented from feeling uncomfortable by maintaining the operation mode.

In the upper braking unit SA, the target gradient dPx corresponding to a change amount per unit time of at least one of the target servo pressure Pat (an absolute value) and the target supply pressure Pst (an absolute value) is determined. For example, a larger one of the servo pressure gradient dPa corresponding to a change amount per unit time of the target servo pressure Pat and the supply pressure gradient dPs corresponding to a change amount per unit time of the target supply pressure Pst is determined as the target gradient dPx. The first and second threshold pressures Ha and Hs are determined to increase as the target gradient dPx increases.

Since the hydraulic pressure generation unit PU is an on-demand type, the hydraulic pressure generation unit PU is stopped when there is no braking request (during non-braking). Then, the hydraulic pressure generation unit PU is activated simultaneously with the generation of a braking request. There is a limit on responsiveness of the hydraulic pressure generation unit PU. For example, even if the braking request amount Bs is rapidly increased when the hydraulic pressure generation unit PU is activated, a rotation speed of the electric motor MA cannot be increased stepwise. In the braking control device SC, since the first and second threshold pressures Ha and Hs are set based on the target gradient dPx (a generic name for dPa and dPs), the first and second abnormalities are prevented from being unnecessarily determined.

In the lower braking unit SZ, in the case of the first and second abnormalities, complementary control is performed to increase the supply pressure Ps. Specifically, in the complementary control, the supply pressure Ps is increased based on the deviation hPs between the detected supply pressure Psk and the target supply pressure Pst (the supply pressure deviation). The supply pressure deviation hPs represents a shortage of the detected supply pressure Psk relative to the target supply pressure Pst. Therefore, the wheel pressure Pw is increased from the supply pressure Ps by the supply pressure deviation hPs. That is, in the case of the first and second abnormalities, the wheel pressure Pw is compensated by a necessary amount by the complementary control. In addition, in the case of the first abnormality, the operation force Fp can be reduced.

1. A vehicle braking control device comprising:
an upper braking unit configured to output a supply pressure by making a servo pressure generated by a hydraulic pressure generation unit match with a target servo pressure calculated based on an operation amount of a braking operation member; and
a lower braking unit disposed between the upper braking unit and a wheel cylinder, wherein
the upper braking unit stops the hydraulic pressure generation unit in a case of a first abnormality in which the servo pressure is insufficient, and continues an operation of the hydraulic pressure generation unit in a case of a second abnormality in which the servo pressure is sufficient but the supply pressure is insufficient, and
the lower braking unit increases the supply pressure and outputs the increased supply pressure to the wheel cylinder in the case of the first and second abnormalities.

2. The vehicle braking control device according to claim 1, further comprising:
a servo pressure sensor configured to detect the servo pressure as a detected servo pressure; and
a supply pressure sensor configured to detect the supply pressure as a detected supply pressure, wherein
the upper braking unit is configured to
set a first allowable range according to the target servo pressure and a first threshold pressure, and set a second allowable range according to a target supply pressure corresponding to the supply pressure and a second threshold pressure, and
determine the first abnormality when the detected servo pressure transitions out of the first allowable range, and determine the second abnormality when the detected servo pressure transitions within the first allowable range but the detected supply pressure transitions out of the second allowable range.

3. The vehicle braking control device according to claim 2, wherein
the upper braking unit is configured to
generate the supply pressure by an operation force of the braking operation member in the case of the first abnormality, and
generate the supply pressure by the servo pressure in the case of the second abnormality, and apply the operation force using a stroke simulator.

4. The vehicle braking control device according to claim 1, wherein
the upper braking unit is configured to
generate the supply pressure by an operation force of the braking operation member in the case of the first abnormality, and
generate the supply pressure by the servo pressure in the case of the second abnormality, and apply the operation force using a stroke simulator.
